(19) United States
(12) Patent Application Publication
(10) Pub. No.: US 2013/0165049 A1
(43) Pub. Date: Jun. 27, 2013

(54) APPARATUS AND METHOD FOR CONTROLLING IN-DEVICE COEXISTENCE INTERFERENCE IN WIRELESS COMMUNICATION SYSTEM

(71) Applicant: Pantech Co., Ltd., Seoul (KR)

(72) Inventors: Jae Hyun AHN, Seoul (KR); Ki Bum KWON, Seoul (KR); Myung Cheul JUNG, Seoul (KR); Kang Suk HUH, Seoul (KR)

(73) Assignee: Pantech Co., Ltd., Seoul (KR)

(21) Appl. No.: 13/728,454

(22) Filed: Dec. 27, 2012

(30) Foreign Application Priority Data
Dec. 27, 2011 (KR) 10-2011-0143961
Jul. 13, 2012 (KR) 10-2012-0076956

(51) Int. Cl. H04B 7/24

(52) U.S. Cl. CPC H04B 7/24
USPC 455/63.1

(57) ABSTRACT

There are provided a method and apparatus in which a User Equipment (UE) controls In-Device Coexistence (IDC) interference in a wireless communication system. Exemplary embodiments of the present invention provides a method including transmitting, to a base station (BS), UE capability information of whether the UE has a capability to control IDC, receiving, from the BS, IDC indication configuration information of whether the IDC is on-going, and transmitting, to the BS, a measurement result in consideration of IDC or a measurement result without consideration of IDC and IDC indication based on the IDC indication configuration information. According to exemplary embodiments of the present invention, UE can send information related to IDC interference to an evolved NodeB (eNB).

### CROSS-REFERENCE TO RELATED APPLICATIONS

This application claim priority from and the benefit of Korean Patent Application No. 10-2011-0143961, filed on Dec. 27, 2011, and 10-2012-0076956, filed on Jul. 13, 2012, which are hereby incorporated by reference for all purposes as if fully set forth herein.

### BACKGROUND

1. Field

The following description relates to a wireless communication system and, more particularly, to an apparatus and method for controlling In-Device Coexistence (IDC) interference in a wireless communication system.

2. Discussion of the Background

In order to support an increased transmission capacity, 3rd generation partnership project (3GPP) long term evolution (LTE) or IEEE 802.16m needs an extended bandwidth thereof up to 20 MHz or more in recent years. The bandwidth may need to increase to increase the transmission capacity, but supporting a large bandwidth even when a required service level is low may cause large power consumption. Accordingly, technical trade-off may occur.

Also, in recent years, as functions of a single terminal have been advanced and became more complicated, the user can communicate with a plurality of network systems simultaneously by using only the single terminal and user convenience has increased. However, when one terminal performs communication on a plurality of network system bands simultaneously, In-Device Coexistence interference (IDC) may occur. The in-device coexistence interference (IDC) may refer to an interference that may occur when transmission in any one frequency band interferes reception in another frequency band. For example, the in-device coexistence interference may occur between a Bluetooth® system band and a 802.16 system band when one terminal supports both a Bluetooth® system and a 802.16 system.

The in-device coexistence interference may occur primarily when a spacing interval of a frequency band boundary of a heterogeneous network system is not sufficiently large, and recent wireless system needs a solution to avoid or control in-device coexistence interference.

### SUMMARY

Exemplary embodiments of the present invention provide an apparatus and method for controlling In-Device Coexistence interference (IDC) interference.

Exemplary embodiments of the present invention provide a method and apparatus is for transmitting information on a User Equipment (UE) capabilities related to IDC interference.

Exemplary embodiments of the present invention provide a method and apparatus for transmitting information to enable operation related to IDC interference.

Exemplary embodiments of the present invention provide a method and apparatus for transmitting and receiving an operation indicating entering on-going IDC interference situation.

Exemplary embodiments of the present invention provide a method and apparatus for transmitting and receiving an operation indicating releasing on-going IDC interference situation.

Exemplary embodiments of the present invention provide a method and apparatus for transmitting and receiving a message indicating IDC interference.

Exemplary embodiments of the present invention provide a method and apparatus for transmitting and receiving a message permitting to transmit a message indicating IDC interference.

Exemplary embodiments of the present invention provide a method for controlling IDC by a UE in a wireless communication system including transmitting, to a base station (BS), UE capability information of whether the UE has capability to control IDC; receiving, from the BS, IDC indication configuration information of whether the IDC is on-going; and transmitting, to the BS, a measurement result in consideration of IDC or a measurement result without consideration of IDC and IDC indication based on the IDC indication configuration information.

Exemplary embodiments of the present invention provide a user equipment (UE) for controlling In-Device Coexistence interference (IDC) in a wireless communication system is including transmitting unit transmitting, to a base station (BS), UE capability information of whether the UE has a capability to control IDC; and receiving unit receiving, from the BS, IDC indication configuration information of whether the IDC is on-going. The transmitting unit may transmit, to the BS, a measurement result in consideration of IDC or a measurement result without consideration of IDC and IDC indication based on the IDC indication configuration information.

Exemplary embodiments of the present invention provide a method for controlling In-Device Coexistence interference (IDC) by a Base Station (BS) in a wireless communication system including receiving, from a User Equipment (UE), UE capability information of whether a UE has a capability to control IDC; transmitting, to the UE, IDC indication configuration information of whether the IDC is on-going; and receiving, from the UE, a measurement result in consideration of IDC or a measurement result without consideration of IDC and IDC indication based on the IDC indication configuration information.

Exemplary embodiments of the present invention provide a Base Station (BS) for controlling In-Device Coexistence interference (IDC) in a wireless communication system including receiving unit receiving, from a User Equipment (UE), UE capability information of whether a UE has a capability to control IDC; and transmitting unit transmitting, to the UE, IDC indication configuration information of whether the IDC is on-going. The receiving unit may receive, from the UE, a measurement result in consideration of IDC or a measurement result without consideration of IDC and IDC indication based on the IDC indication configuration information.

According to exemplary embodiments of the present invention, UE can transmit messages indicating IDC interference occurrence from an evolved NodeB (eNB), receive is messages in regard to IDC interference-related information to the eNB, and operate to avoid or resolve the occurrence of IDC interference. More specifically, a UE may communicate in multiple network systems in the same time, but can be serviced without interference to support other services in the determined frequency band. Accordingly, user convenience can be elevated.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 illustrates a wireless communication system according to exemplary embodiments of the present invention.

FIG. 2 is a diagram illustrating in-device coexistence interference according to exemplary embodiments of the present invention.

FIG. 3 illustrates in-device coexistence interference from an industrial, scientific and medical (ISM) transmitter to a long term evolution (LTE) receiver according to exemplary embodiments of the present invention.

FIG. 4 illustrates a band divided into an ISM band and an LTE band on a frequency band according to exemplary embodiments of the present invention.

FIG. 5 is a diagram illustrating alleviation of an in-device coexistence interference according to exemplary embodiments of the present invention.

FIG. 6 is a diagram illustrating alleviation of an in-device coexistence interference according to exemplary embodiments of the present invention.

FIG. 7 is a diagram illustrating alleviation of an in-device coexistence interference according to exemplary embodiments of the present invention.

FIG. 8 is a diagram illustrating alleviation of an in-device coexistence interference according to exemplary embodiments of the present invention.

FIG. 9 is a diagram illustrating alleviation of an in-device coexistence interference according to exemplary embodiments of the present invention.

FIG. 10 is a diagram illustrating alleviation of an in-device coexistence interference according to exemplary embodiments of the present invention.

FIG. 11 is a diagram illustrating alleviation of an in-device coexistence interference according to exemplary embodiments of the present invention.

FIG. 12 is a diagram illustrating alleviation of an in-device coexistence interference according to exemplary embodiments of the present invention.

FIG. 13 is a diagram illustrating alleviation of an in-device coexistence interference according to exemplary embodiments of the present invention.

FIG. 14 illustrates a UE receiving an interference signal within the UE according to exemplary embodiments of the present invention.

FIG. 15 is a flowchart illustrating an operation of UE and an eNB performing IDC interference control according to exemplary embodiments of the present invention.

FIG. 16 illustrates a frequency band including a possibility of IDC interference according to exemplary embodiments of the present invention.

FIG. 17 is a diagram illustrating a UE performing measurement including IDC interference or measurement not including IDC interference according to exemplary embodiments of the present invention.

FIG. 18 is a flowchart illustrating an operation of UE that performs an in-device coexistence interference avoidance (ICO) operation according to exemplary embodiments of the present invention.

FIG. 19 is a flowchart illustrating an operation of an eNB which performs an ICO operation according to exemplary embodiments of the present invention.

FIG. 20 is a block diagram illustrating an apparatus for transmitting and receiving information on IDC interference according to exemplary embodiments of the present invention.

### DETAILED DESCRIPTION OF THE ILLUSTRATED EMBODIMENTS

Hereinafter, in this specification, some exemplary embodiments will be described in detail with reference to the accompanying drawings. In adding reference numerals to components throughout the drawings, it is to be noted that like reference numerals designate like components even though components are shown in different drawings. Further, in describing exemplary embodiments of the present invention, well-known functions or constructions will not be described in detail since they may unnecessarily obscure the understanding of aspects of the present invention.

Further, in describing components of the specification, terms such as first, second, A, B, (a), (b), and like may be used. These terms are just used to discriminate the components to from other components and a property, an order, or a sequence of the corresponding component is not limited by the term. It will be understood that when an element is simply referred to as being ‘connected to’ or ‘coupled to’ another element without being ‘directly connected to’ or ‘directly coupled to’ another element in the present description, it may be ‘directly connected to’ or ‘directly coupled to’ another element or be connected to or coupled to another element, having is the other element intervening there between.

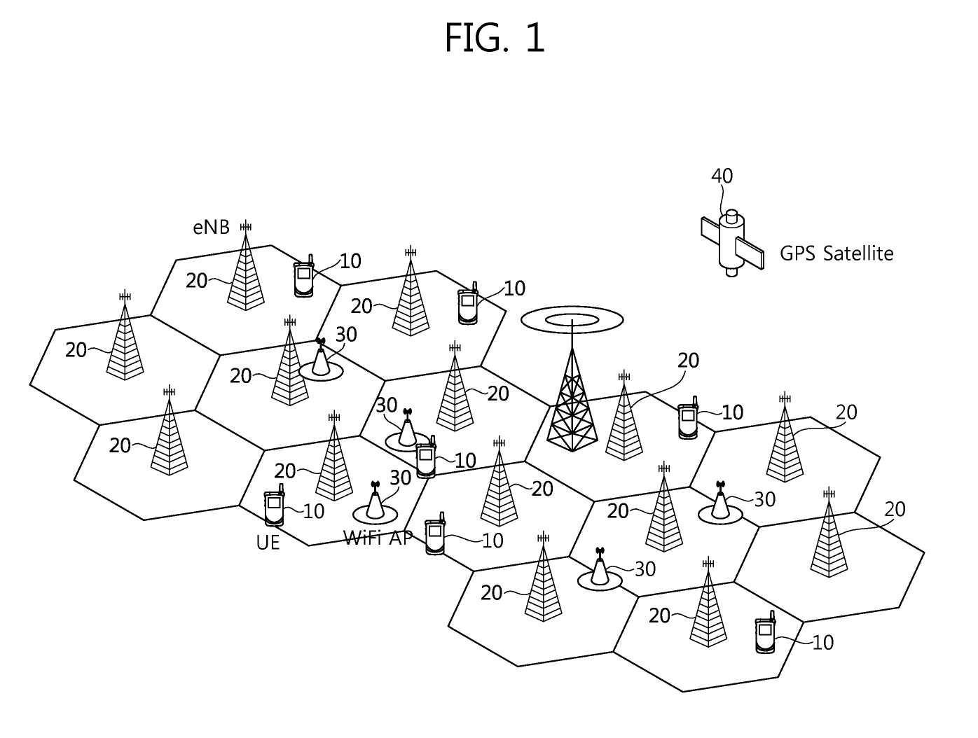

FIG. 1 illustrates a wireless communication system according to exemplary embodiments of the present invention.

Referring to FIG. 1, the wireless communication system is widely placed in order to provide various communication services including voice, packet, data, and the like, and includes a terminal (also may called as a user equipment (UE)) 10, a base station (BS, or called as a evolved NodeB (eNB)) 20, a wireless LAN access point (AP) 30, a global positioning system (GPS) 40, and a satellite. Herein, a wireless LAN is a device supporting IEEE 802.11 technology which a wireless standard and the IEEE 802.11 may be mixed with a WiFi system.

The UE 10 may be positioned in coverage of a plurality of networks including a cellular network, a wireless LAN broadcast network, a satellite system, and the like. The UE 10 is provided with a plurality of wireless transceivers in order to access various networks and various services regardless of place and time. For example, a smart phone is provided with long term evolution (LTE), WiFi transceiver, Bluetooth transceiver, and a GPS receiver. A design of the UE 10 becomes more complicated in order to integrate more and more transceivers in one same UE 10 while maintaining excellent performance. As a result, a possibility that in-device coexistence interference (IDC) in the UE will occur may be further increased.

Hereinafter, a downlink (DL) indicates communication from the eNB 20 and an uplink (UL) indicates communication from the UE 10 to the eNB 20. In the downlink, a transmitter may be a part of the eNB 20 and a receiver may be a part of the UE 10. In the uplink, the transmitter may be a part of the UE 10 and a receiver may be a part of the eNB 20.

The UE 10 may be fixed or have mobility, and may be called other terms such as a mobile station (MS), a user terminal (UT), a subscriber station (SS), a mobile terminal (MT), a is wireless device, and the like. The eNB 20 indicates a fixed station that communicates with the UE 10 and may be called other terms such as a base station (BS), a base transceiver system (BTS), an access point, a femto base station (BS), a relay, and the like.

Multiple access techniques applied to the wireless communication system are not limited. Various multiple access techniques, such as CDMA (Code Division Multiple Access), TDMA (Time Division Multiple Access), FDMA (Frequency Division Multiple Access), OFDMA (Orthogonal Frequency Division Multiple Access), SC-FDMA (Single Carrier-FDMA), OFDM-FDMA, OFDM-TDMA, and OFDM-CDMA may be used. In uplink transmission and downlink transmission, a time division duplex (TDD) scheme in which transmission is performed by using different times may be used or a frequency division duplex (FDD) scheme in which transmission is performed by using different frequencies may be used.

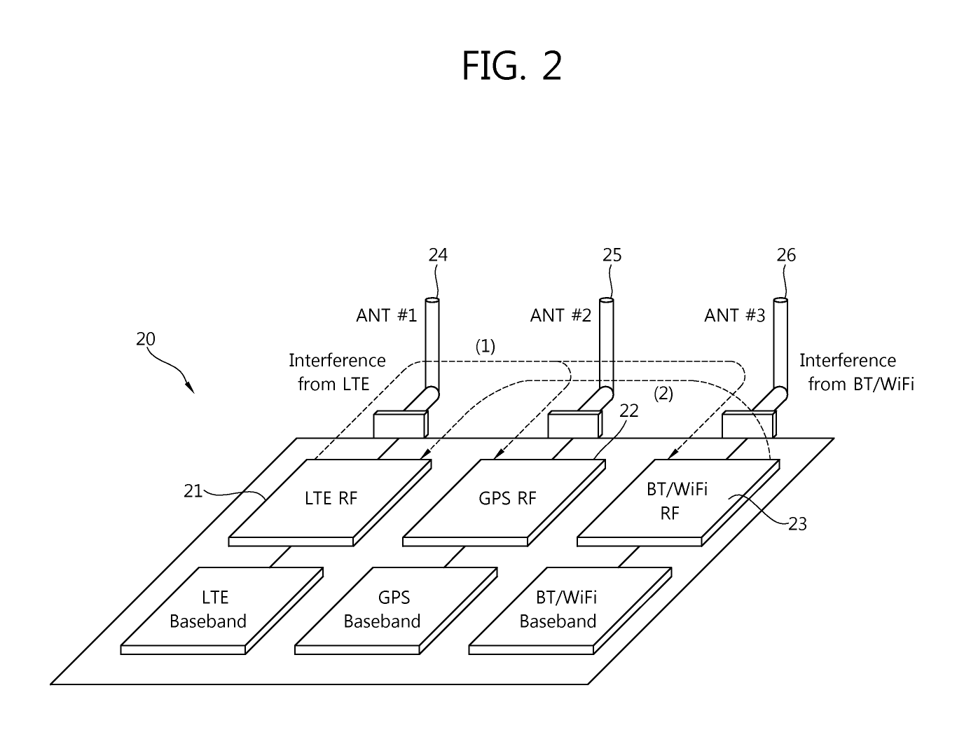

FIG. 2 is a diagram illustrating in-device coexistence interference according to exemplary embodiments of the present invention.

Referring to FIG. 2, the eNB 20 includes an LTE RF 21, a GPS RF 22, and a Bluetooth/WiFi RF 23. Transceiving antennas 24, 25, and 26 are connected to the respective RFs. That is, various types of RFs are closely mounted in one device platform. Herein, transmission power of one RF may be much larger than a reception power level into another RF receiver. In this case, if an interval in frequency between the RFs is not sufficient and a filtering technique is not supported, a transmission signal of any RF may cause remarkable interference in a receiver of another RF within the device. For example, ‘(1)’ is an example in which the transmission signal of the LTE RF 21 causes the in-device coexistence interference in the GPS RF 22 and the Bluetooth/WiFi RF 23 and ‘(2)’ is an example in which the transmission signal of the Bluetooth/WiFi RF 23 causes the in-device coexistence interference in the LTE RF 21.

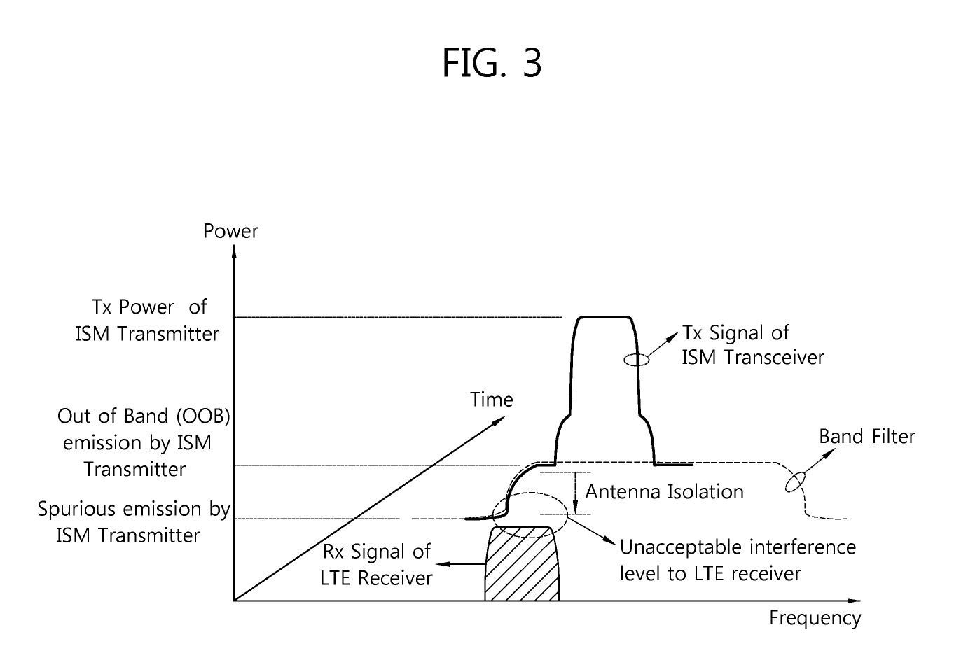

FIG. 3 illustrates in-device coexistence interference from an industrial, scientific and medical (ISM) transmitter to an LTE receiver according to exemplary embodiments of the present invention. The ISM band indicates a band which may be arbitrarily used without authorizing the use in industrial, scientific, and medical fields.

Referring to FIG. 3, a band of a signal received by the LTE receiver overlaps with a band of a transmission signal of the ISM transmitter. In this case, the in-device coexistence interference may occur.

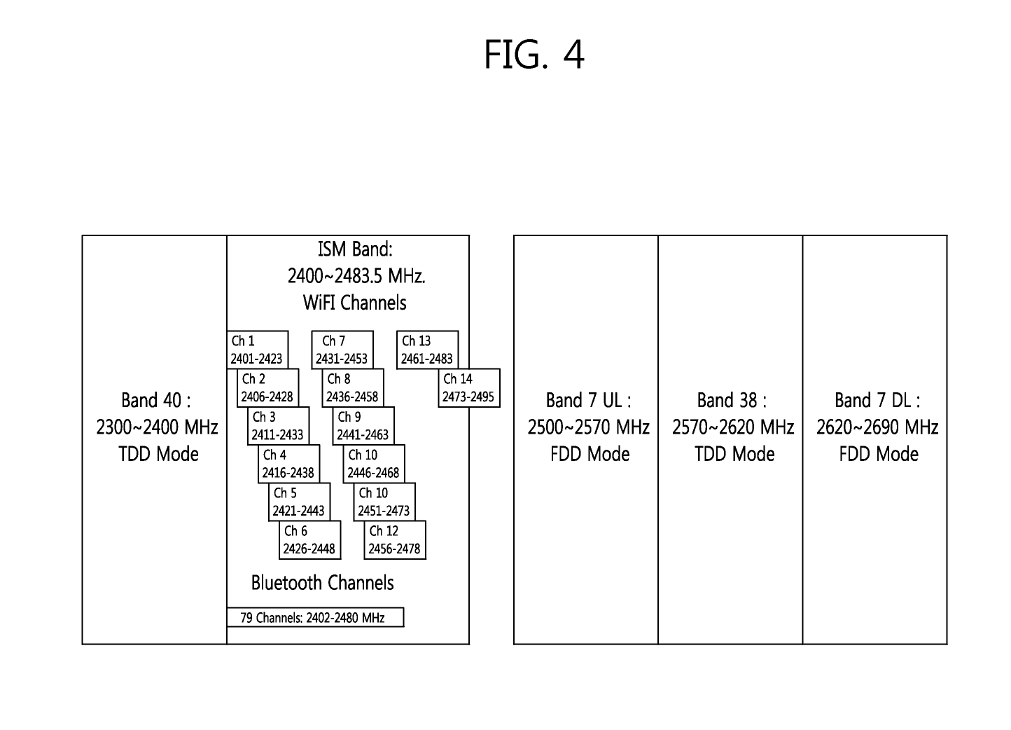

FIG. 4 illustrates a band divided into an ISM band and an LTE band on a frequency band according to exemplary embodiments of the present invention.

Referring to FIG. 4, a band 40, a band 7, and a band 38 are LTE bands. The band 40 occupies a band in the range of 2300 to 2400 MHz in a TDD mode and the band 7 occupies a band in the range of 2500 to 2570 MHz as the uplink in an FDD mode. In addition, the band 38 occupies a band in the range of 2570 to 2620 MHz in the TDD mode. Meanwhile, the ISM band is used as a WiFi channel and a Bluetooth channel, and occupies a band in the range of 2400 to 2483.5 MHz. Herein, a condition in which the in-device coexistence interference occurs is illustrated in Table 1 below.

TABLE 1

| Interference band | Pattern of interference |
|---|---|
| Band 40 | ISM Tx -> LTE TDD DL Rx |
| Band 40 | LTE TDD UL Tx -> ISM Rx |
| Band 7 | LTE FDD UL Tx -> ISM Rx |
| Band 7/13/14 | LTE FDD UL Tx -> GPS Rx |

Referring to Table 1, a mark of ‘a>b’ in the interference pattern illustrates a condition in which a transmitter a causes the in-device coexistence interference to a receiver b. Therefore, in the band 40, the ISM transmitter causes the in-device coexistence interference to an LTE-band downlink TDD receiver (LTE DL TDD Rx). The in-device coexistence interference may be alleviated to some extent by a filtering scheme, but is not sufficient to alleviate the in-device coexistence interference. When a frequency division multiplex (FDM) scheme is is additionally applied to the filtering scheme, the in-device coexistence interference may be more efficiently alleviated.

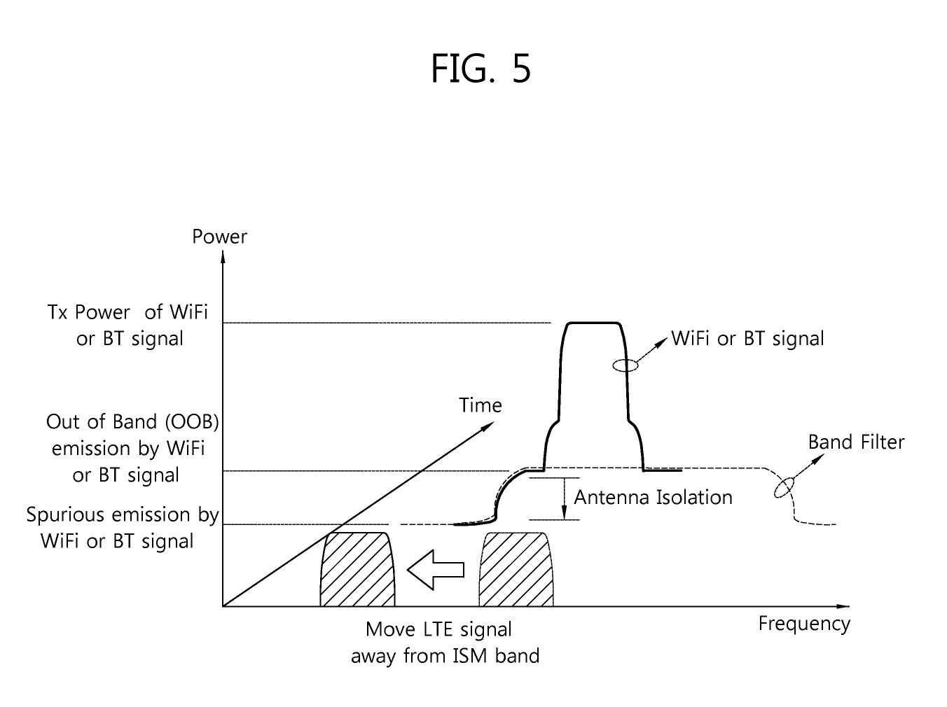

FIG. 5 is a diagram illustrating alleviation of an in-device coexistence interference by using an FDM scheme according to exemplary embodiments of the present invention.

Referring to FIG. 5, the LTE band may be moved so as to prevent the LTE band and the ISM band from overlapping with each other. As a result, a handover of the terminal is induced from the ISM band. However, to this end, a method in which legacy measurement or new signaling accurately triggers a mobility procedure or a radio link failure (RLF) procedure is required. Alternatively, a part which becomes a problem associated with the ISM in the LTE band may be avoided through a filtering or resource allocation technique. Alternatively, overlapping interference may be avoided with respect to a case in which LTE carriers are compiled through a procedure of reconfiguring a set of used carriers.

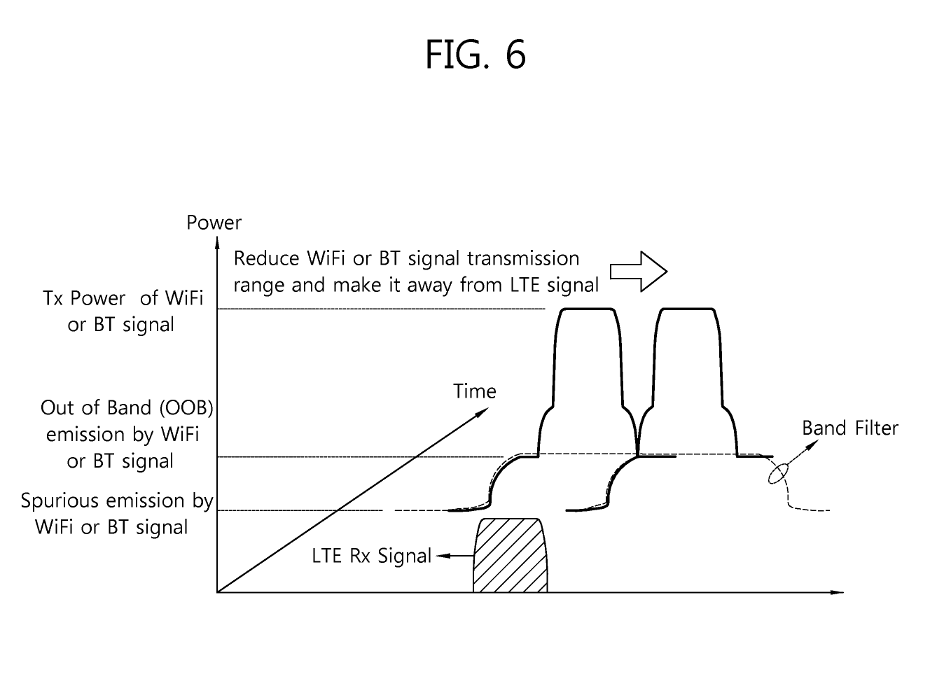

FIG. 6 is a diagram illustrating alleviation of an in-device coexistence interference by using the FDM scheme according to exemplary embodiments of the present invention.

Referring to FIG. 6, the ISM band may be reduced and moved so as to be spaced apart from the LTE band. However, in this scheme, backward compatibility problem may occur. In the case of the Bluetooth, the backward compatibility problem may be resolved due to an adaptive frequency hopping mechanism to some extent, but in the case of the WiFi, it may be is difficult to resolve the backward compatibility problem.

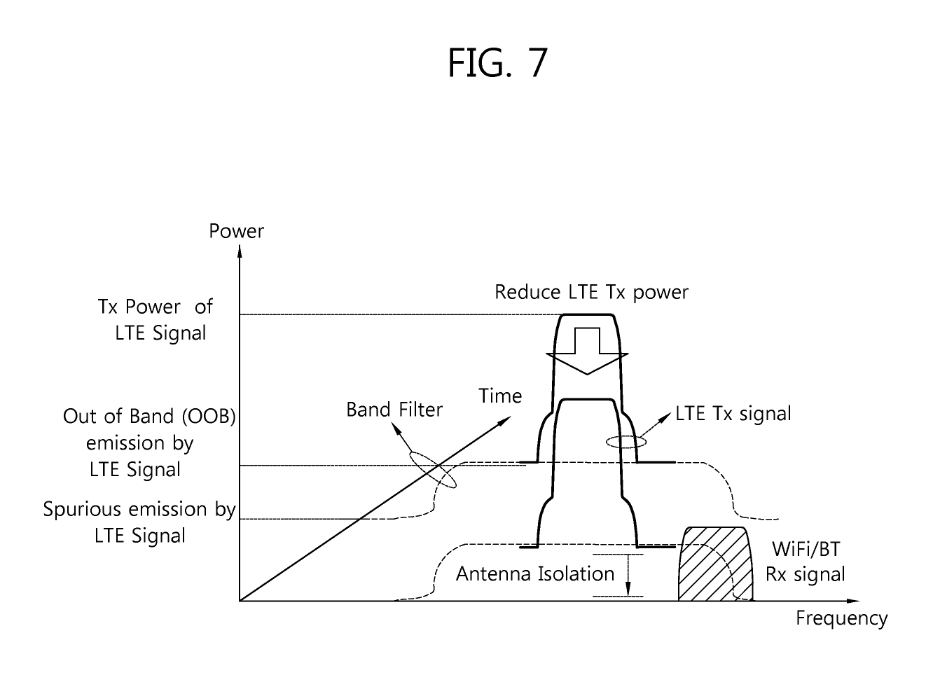

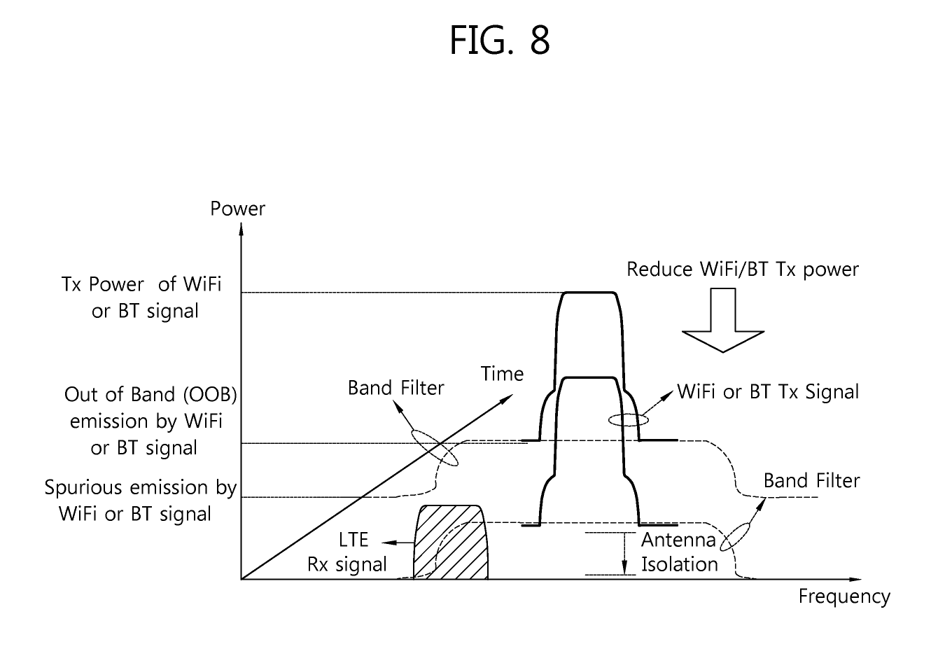

FIGS. 7 and 8 are diagrams illustrating alleviation of an in-device coexistence interference by using a power control (PC) scheme according to exemplary embodiments of the present invention.

Referring to FIG. 7, the terminal avoids the in-device coexistence interference by lowering transmission power of the LTE signal by a predetermined level to improve reception quality of the ISM band and referring to FIG. 8, the terminal avoids the in-device coexistence interference by lowering transmission power of the ISM band by a predetermined level to improve reception quality of the LTE signal.

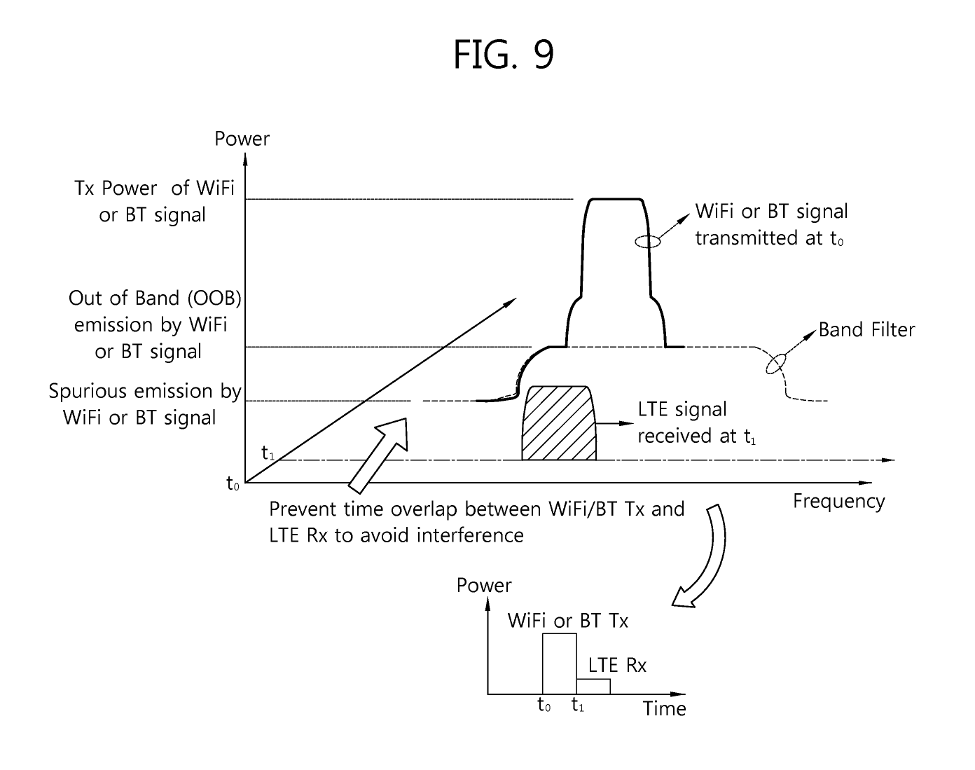

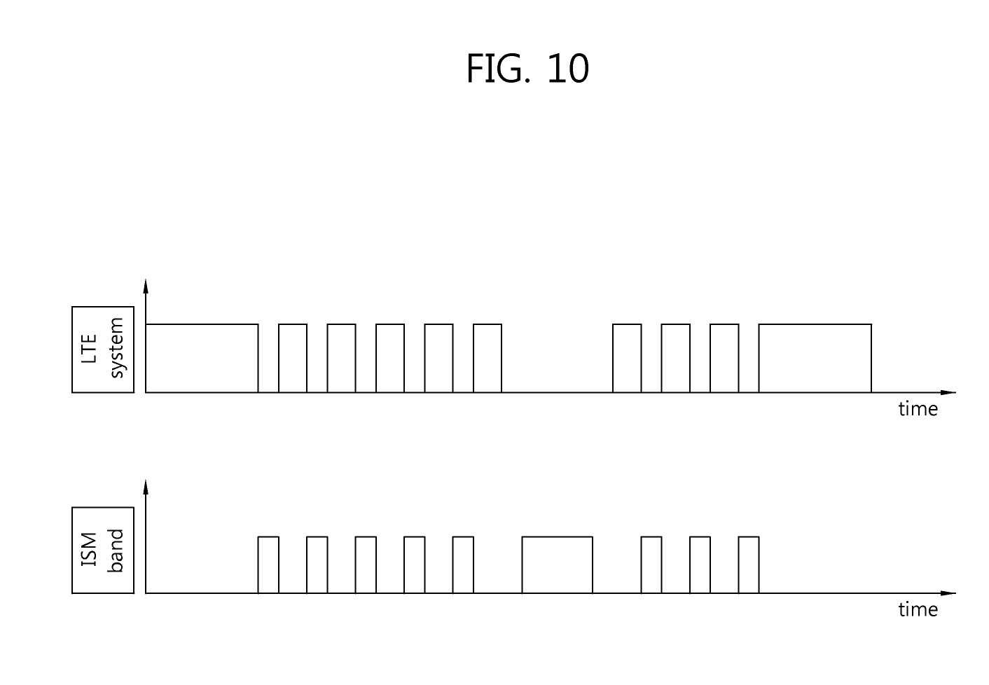

FIGS. 9 and 10 are diagrams illustrating alleviation of an in-device coexistence interference by using the time division multiplex (TDM) scheme according to exemplary embodiments of the present invention.

Referring to FIG. 9, when a reception time of the LTE signal is prevented from overlapping with a transmission time in the ISM band, the in-device coexistence interference may be avoided. For example, when the signal in the ISM band is transmitted at t0, the LTE signal is received at t₁. As such, according to exemplary embodiments of the present invention, transmission/reception timings on time axes in the LTE band and the ISM band using the TDM scheme may be illustrated in FIG. 10.

Referring to FIG. 10, the in-device coexistence interference may be avoided without movement between the LTE band and the ISM band by the scheme of FIG. 9.

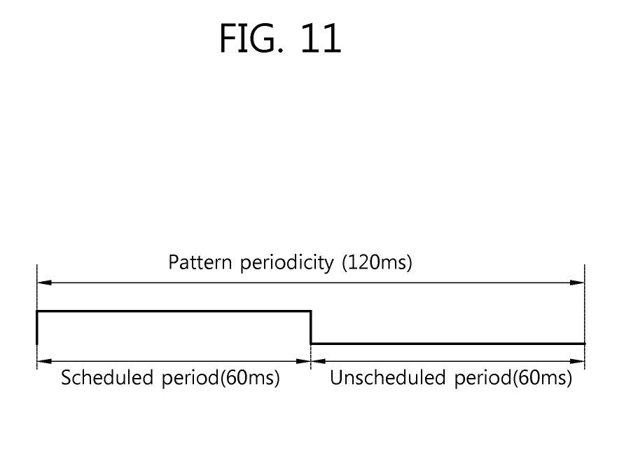

FIG. 11 is a diagram illustrating alleviation of an in-device coexistence interference according to exemplary embodiments of the present invention.

Referring to FIG. 11, a predetermined pattern periodicity interval is divided into a is scheduled period interval and an unscheduled period interval to avoid the in-device coexistence interference by the TDM scheme based on discontinuous reception (DRX).

Mutual interference between the LTE and the ISM is avoided by preventing the LTE from being transmitted within the unscheduled period interval. However, primary LTE transmission such as random access and hybrid automatic repeat request (HARQ) retransmission may be permitted even within the scheduled period interval.

Mutual interference between the LTE and the ISM is avoided by preventing the ISM from being transmitted and permitting the LTE to be transmitted within the scheduled period interval. The primary ISM transmission such as Beacon or WiFi may be permitted even within the scheduled period interval, similarly as the unscheduled period interval. The LTE transmission may be prevented in order to protect the primary ISM transmission. Special signaling for protecting the primary ISM transmission such as Beacon may be added. As one example, a period of the Beacon signaling and information on a subframe offset may be added. In this case, the subframe offset number and the system frame number may be determined based on ‘0’. The system frame number may have one of ‘0’ to ‘1023’ by the unit of a radio frame in the LTE system. One radio frame is constituted by ten subframes. When the corresponding subframe offset number and system frame number are known, an accurate frame position may be known in the corresponding system. The corresponding period or offset may be used as information to choose proper DRX period of DRX offset.

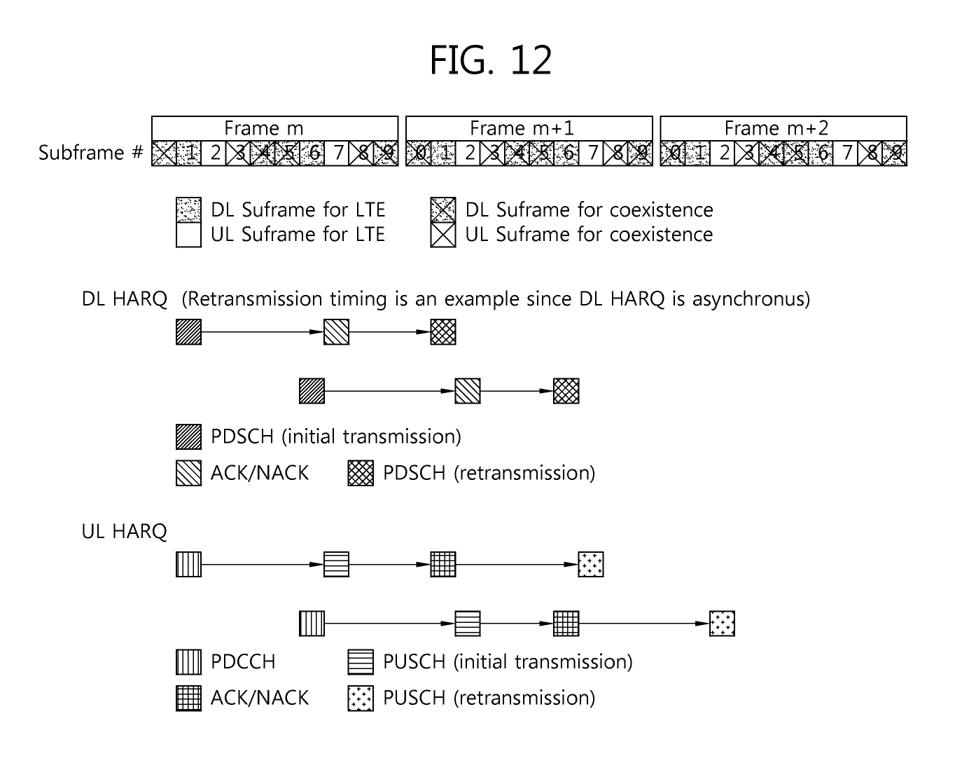

FIG. 12 is a diagram illustrating alleviation of an in-device coexistence interference according to exemplary embodiments of the present invention.

Referring to FIG. 12, by the TDM scheme based on the HARQ, a retransmission signal is preferably protected when data is transmitted based on the HARQ. Herein, being is protected may mean that retransmission is achieved successfully. If retransmission is not achieved in order to alleviate or avoid the in-device coexistence interference in the TDM scheme, the performance of the system will deteriorate. Based on this point, a transmission pattern is determined by considering a retransmission period. For DL transmission, subframes 1 and 6 are reserved in advance and for UL transmission, subframes 2 and 7 are reserved. These are called scheduled subframes. Unscheduled subframes for alleviating the in-device coexistence interference are not used in transmission in order to protect the ISM band.

Even in a scheme based on the HARQ similarly as a scheme based on DRX, the subframes reserved for transmission may be prevented from being transmitted in order to transmit a primary signal in the ISM. On the contrary, even in the unscheduled subframes, primary messages such as random access, system information, and a paging signal may be permitted to be transmitted.

The pattern may be given as a bitmap pattern. That is, the number of subframes indicated by one bit may be one or more. The period of the pattern is ‘the total length of the bitmap*the number of subframes per bit’, and each bit may be ‘0’ when a subframe directed by the bit is the scheduled subframe and each bit may be ‘1’ when the corresponding subframe is the unscheduled subframe. On the contrary, when each subframe is the scheduled subframe, each bit may be ‘1’ and when each subframe is the unscheduled subframe, each bit may be ‘0’.

For example, it is assumed that the period is ‘20’, a pattern expressing the subframe is ‘1001001000’, the unscheduled subframe is ‘0’, and the number of the subframes indicated by one bit is two. In the pattern representing the subframe, since first, fourth, and seventh bits are ‘1’, subframes 0, 1, 6, 7, 12, and 13 are the scheduled subframes every period.

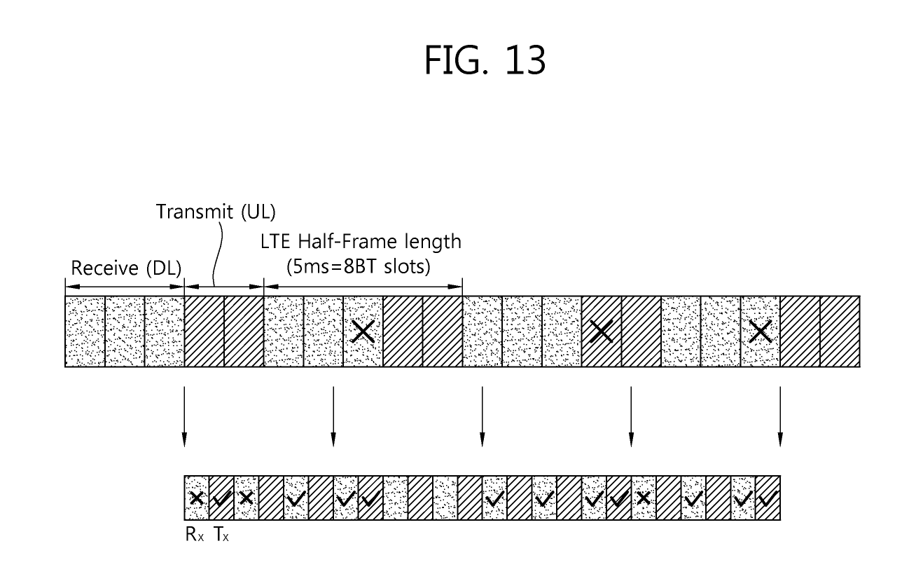

FIG. 13 is a diagram illustrating alleviation of an in-device coexistence interference according to exemplary embodiments of the present invention.

Referring to FIG. 13, by an autonomously denial scheme, when the in-device coexistence interference occurs in the terminal, transmission of the LTE is denied in order to protect the reception of the ISM. Herein, a ticked part means that transmission or reception is approved and a part marked by ‘X’ means that transmission or reception is denied. As an example, even though UL transmission is granted from the base station, the terminal denies granting not to perform UL transmission in order to protect the reception of the ISM. Similarly, transmission of the ISM is denied in order to protect the reception of the LTE.

Here, a method of controlling IDC interference according to exemplary embodiments of the present invention is described below. Hereinafter, an operation of reducing, avoiding, or removing interference is generally called interference control or interference coordination.

Scenarios regarding the on-going IDC state of UE are listed in Table 2 below.

TABLE 2

| SCENARIO | DEFINITION |
|---|---|
| 1 | On-going IDC interference in a serving frequency band |
| 2 | Potential IDC interference existence in a serving frequency |
| | band (not on-going IDC interference) |
| 3 | On-going IDC interference in a frequency band not a serving |
| | frequency band |
| 4 | Potential IDC interference existence in a frequency band not |
| | a serving frequency band (not on-going IDC interference) |

Each of the scenarios indicates an interference state on the basis of the type of interference and a frequency band. An unusable frequency is not related to whether it is a serving frequency band or not and thus the scenario 1 and the scenario 3 correspond to on-going IDC interference.

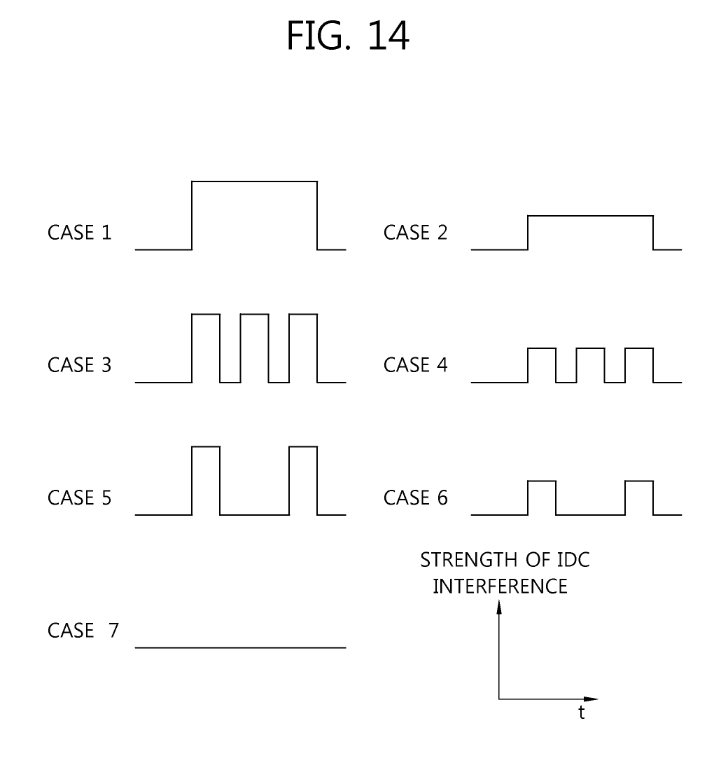

FIG. 14 illustrates a UE receiving an interference signal within the UE according to exemplary embodiments of the present invention. There are 7 types of cases based on the frequency and strength (or power) of interference.

Referring to FIG. 14, the 7 types of cases are classified into four patterns as follows based on the frequency of interference. The case 1 and the case 2 correspond to is continuous patterns, the case 3 and the case 4 correspond to burst patterns, the case 5 and the case 6 correspond to sparse patterns, and the case 7 corresponds to a noise pattern.

The 7 types of cases are classified into three patterns as follows on the basis of the strength of interference. The case 1, the case 3, and the case 5 correspond to patterns that are too strong, the case 2, the case 4, and the case 6 correspond to patterns that are too weak, and the case 7 correspond to a none pattern.

For example, if the IDC interference of UE is determined to be on-going, it may correspond to the case 1 and the case 3. The cases correspond to cases where interference is at least continuous or a burst and correspond to cases where the strength is too strong.

Meanwhile, a state in which IDC interference has occurred, although not corresponding to on-going IDC interference, and the IDC interference has a possibility that it will be changed into an on-going state is defined as ‘potential IDC interference existence’.

For example, UE may determine the case 2, the case 4, the case 5 and the case 6 of FIG. 14 to be potential IDC interference existence. For another example, UE may determine only the case 5 having too strong of strength to be potential IDC interference existence. A handover or RRC configuration/reconfiguration is not impossible in a frequency band including is potential IDC interference existence, and UE may perform measurement in the frequency band.

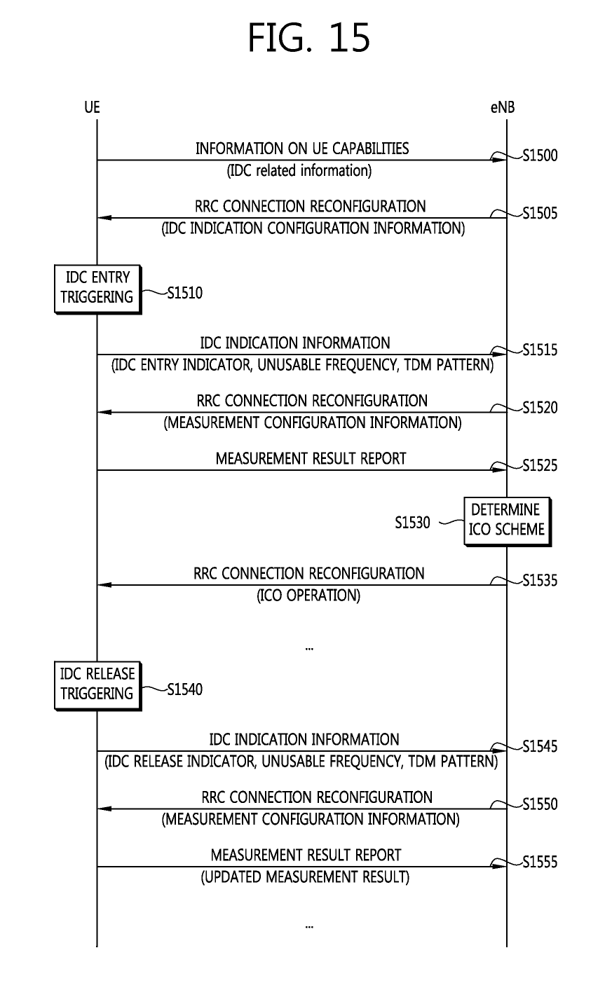

FIG. 15 is a flowchart illustrating an operation of UE and an eNB performing IDC interference control according to exemplary embodiments of the present invention.

Referring to FIG. 15, the UE transmits information on UE capabilities to the eNB at step S1500.

The information on UE capabilities may include information on a possibility that IDC interference may exist (i.e., an IDC interference existence possibility), information on a frequency band having a possibility that IDC interference may exist (i.e., an IDC interference-possible frequency), information on a frequency band having a possibility that IDC interference may not exist, or information on a frequency band including potential IDC interference existence.

The frequency band including a possibility that IDC interference may exist refers to a frequency band including a possibility that the frequency band may be an unusable frequency. The unusable frequency refers to a frequency on which it is difficult to perform wireless communication because on-going IDC interference exists in the corresponding frequency. For example, although there is no coexistence interference at the time of LTE initial access because the Wi-Fi of UE is not turned on, a band 40 is a frequency band including a possibility that the band may be an unusable frequency due to on-going coexistence interference to in the UE including Wi-Fi. Thus, the band 40 is determined to be a frequency band including a possibility that IDC interference may exist.

The frequency band including a possibility that IDC interference may exist may be indicated by an E-UTRA Absolute Radio Frequency Channel Number (EARFCN). The EARFCN is assigned to an operating frequency band of Evolved-Universal Terrestrial Radio is Access (E-UTRA) after dividing the operating frequency band.

For example, the information on UE capabilities may include all the EARFCNs of a frequency band including a possibility that IDC interference may exist.

For another example, the information on UE capabilities may include an EARFCN corresponding to the bound of the frequency band including a possibility that IDC interference may exist. The bound may be an upper bound or a lower bound.

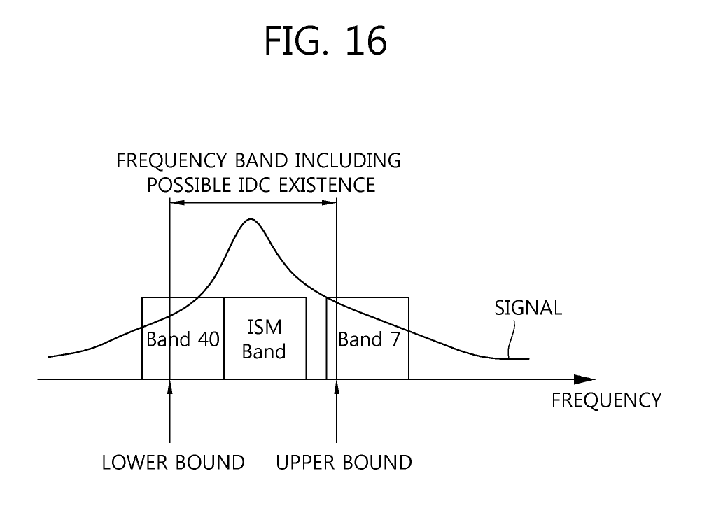

FIG. 16 illustrates a frequency band including a possibility of IDC interference according to exemplary embodiments of the present invention.

Referring to FIG. 16, a frequency band including a possibility that IDC interference may exist is an interval between a lower bound within a band 40 and an upper bound within a band 7.

The information on UE capabilities may include an EARFCN corresponding to the lower bound. The eNB may determine that there is a possibility that the UE may have IDC interference in a frequency band greater than the lower bound based on the EARFCN.

Or, the information on UE capabilities may include an EARFCN corresponding to the upper bound. The eNB may determine that there is a possibility that the UE may have IDC interference in a frequency band smaller than the upper bound based on the EARFCN.

Whether the EARFCN included in the information on UE capabilities is an upper to bound or a lower bound may be previously determined according to 3GPP LTE standards.

Or, an indicator indicating whether an EARFCN is an upper bound or a lower bound may be further included in the information on UE capabilities. The indicator may be said to be a bound type indicator. The eNB may determine a frequency band including a possibility that IDC interference may occur based on the EARFCN and the bound type indicator.

Or, the type of bound may be implicitly determined on the basis of the number of an operating band to which an EARFCN included in the information on UE capabilities belongs. For example, in FIG. 16, the bound of the band 7 is an upper bound, and the bound of the band 40 is a lower bound. Although there is no bound type indicator as described above, an eNB may implicitly determine whether an EARFCN corresponds to what bound based on the number of an operating band to which the EARFCN belongs. This is because different EARFCNs may indicate the same frequency band. In an E-UTRA operating band, frequency bands overlap with each other because the band 7 corresponds to 2500-2570 MHz and 2620-2690 MHz, and the band 40 corresponds to 2496-2690 MHz. However, the band 7 and the band 40 have different numbers of operating bands, the band 7 and the band 40 have different EARFCNs, and the band 7 is an FDD method and the band 40 is a TDD method even in a duplexing method.

For yet another example, the information on UE capabilities includes an EARFCN. The EARFCN may indicate that an operating band region itself where the EARFCN is placed includes a possibility that IDC interference may exist. That is, an operating band unit may be indicated using the EARFCN. For example, if an EARFCN corresponding to a lower bound of FIG. 16 is included in the information on UE capabilities, an eNB may determine that there is a possibility that IDC interference may exist in the band 40 based on the EARFCN.

For yet another example, if a plurality of operating bands is influenced by a frequency band indicated by the EARFCN, an eNB may determine that there is a possibility that IDC interference may exist in all the operating bands. For example, if a frequency indicated by the EARFCN is 2500 MHz, an eNB may determine that there is a possibility that IDC interference may exist in both a band 7 and a band 40 including 2500 MHz.

The information on UE capabilities may further include information on the kind is or type of another communication system that may generate IDC interference. The information on the kind of another communication system may be any one of a Wireless LAN (WLAN), a Bluetooth (BT), and a Global Navigation Satellite System (GNSS). The information on the type of another communication system may be any one of a voice communication type, a streaming type, such as multimedia (e.g., Video On Demand (VOD)), and an offload type. However, aspects of the invention are not limited to the above examples, and information on various types and kinds of communication systems may be included.

The information on UE capabilities may further include information on a frequency band that may generate IDC interference in another communication system along with information on the kind or type of another communication system that may generate IDC interference.

The information on UE capabilities may further include information indicative of the ISM capabilities of UE.

UE may coordinate a maximum transmission value of LTE uplink transmission power and reduce interference between an LTE band and an ISM band based on the information on the ISM capabilities of the UE.

The information on UE capabilities may further include an In-device coexistence interference avoidance (hereinafter referred to as ‘ICO’) capability indicator indicating whether UE has a capability of performing ICO or not. If the ICO capability indicator indicates that UE does not have a capability of performing an ICO operation, an eNB may determine that it is not necessary to transmit information related to ICO to the UE. For example, the ICO capability indicator may be a bitmap indicator. For example, when the ICO capability indicator is ‘0’, it indicates that there is no capability of performing ICO. When the ICO capability indicator is ‘1’, it indicates that there is a capability of performing ICO.

For example, a UE capability information message may include a physical layer parameter information entity or a measurement parameter information entity, and the physical layer parameter information entity may include an ICO capability indicator. The ICO capability indicator indicates whether UE has a capability of supporting an ICO operation or not. Furthermore, the measurement parameter information entity may include information on a frequency band (i.e., band information) including an on-going IDC interference possibility in the form of a list. The information on a frequency band may include information on not only a frequency band including an on-going coexistence interference possibility, but also a frequency band including potential IDC interference existence.

After the step S1500, the eNB transmits an RRC connection reconfiguration message to the UE at step S1505. The RRC connection reconfiguration message includes information for configuring IDC interference-related information indication (hereinafter referred to as ‘IDC indication’) operation to be performed by the UE.

For example, the RRC connection reconfiguration message includes a threshold used as a condition that triggers an event indicating that the on-going IDC state of UE has been started or ended (hereinafter referred to as an ‘IDC triggering threshold’).

The IDC triggering threshold is an IDC triggering entry threshold or an IDC triggering release threshold. The IDC triggering entry threshold and the IDC triggering release threshold may have the same value or different values. Furthermore, the IDC triggering threshold may be a value related to the measurement value of LTE downlink and may be used as a triggering condition on an interference direction from ISM to LTE.

The IDC triggering threshold may be determined based on a Reference Signal is Receive Power (RSRP) value or a Reference Signal Receive Quality (RSRQ) value. Furthermore, the IDC triggering threshold may be determined based on the strength of IDC interference. Or, the IDC triggering threshold may be determined by taking both the intensity and activity of IDC interference into consideration. The activity of IDC interference means a ratio of an interval where IDC interference is generated within a specific interval. For example, if the strength of IDC interference is a first threshold or higher and the activity of IDC interference is a second threshold or higher, an IDC triggering threshold may be determined so that IDC interference triggering is performed.

Furthermore, the IDC triggering threshold may be differently set according to each frequency band or operating band.

Meanwhile, the UE may perform acknowledgement for the reception of the RRC connection reconfiguration message by sending an RRC reconfiguration completion message to the eNB (not shown).

After the step S1505, the UE triggers an event indicating that an on-going IDC state has been started (hereinafter referred to as ‘IDC entry triggering’) in relation to a usable frequency band at step S1510.

For example, if the UE has received an IDC triggering entry threshold through the RRC connection reconfiguration message, IDC entry triggering may be performed based on the IDC triggering entry threshold.

For another example, if the UE has not received an IDC triggering entry threshold, IDC entry triggering may be performed according to a UE-internal criterion (i.e., ‘UE-internal coordination’).

For yet another example, if UE has not received an IDC triggering entry threshold, IDC entry triggering may be performed based on a predetermined reference value. The predetermined reference value is a value previously determined within a system and is previously known to an eNB and UE without signaling between the eNB and the UE.

The predetermined reference value may be an RSRP value or an RSRQ value. That is, when a measured RSRP or RSRQ value is greater than a predetermined reference value, IDC entry triggering is performed.

Or, the predetermined reference value may be a value related to the strength of IDC interference. That is, when the strength of measured IDC interference is greater than a predetermined reference value, IDC entry triggering is performed.

Or, the predetermined reference value may be a value into which both the intensity and activity of IDC interference are incorporated. That is, when the strength of measured IDC interference is greater than a predetermined reference value and the activity of measured IDC interference is greater than the predetermined reference value, IDC entry triggering is performed.

Meanwhile, the IDC entry triggering may be performed only in a serving cell. Or, the IDC entry triggering may be performed on all the cells of frequency bands having a severe IDC interference problem.

After the step S1510, the UE transmits information related to ICO to the eNB by sending IDC indication information to the eNB at step S1515. That is, the UE performs an IDC indication operation.

The IDC indication information may include an additional IDC entry indicator indicating whether IDC entry triggering will be performed or not. The IDC entry indicator may be a bitmap indicator. For example, when the IDC entry indicator is 0, it indicates that IDC is entry triggering is not performed. When the IDC entry indicator is 1, it indicates that IDC entry triggering is performed.

The IDC indication information may include information on an unusable frequency band or information on a TDM pattern. Here, although the IDC indication information does not include an additional IDC entry indicator, an eNB may implicitly determine a situation of IDC interference of UE, such as whether IDC entry triggering will be performed or not, based on information on an unusable frequency band.

The information on an unusable frequency band may be indicated by an EARFCN.

For example, the IDC indication information may include all the EARFCNs of the unusable frequency band.

For another example, the IDC indication information may include an EARFCN corresponding to the bound of the unusable frequency band. The bound may be an upper bound or a lower bound. If the IDC indication information includes an EARFCN corresponding to the lower bound, an eNB may determine that UE is unable to use a frequency band greater than the lower bound based on the EARFCN. Furthermore, if the IDC indication information includes an EARFCN corresponding to the upper bound, an eNB may determine that UE is unable to use a frequency band greater than the lower bound based on the EARFCN.

Whether an EARFCN included in the IDC indication information is an upper bound or a lower bound may be previously determined according to 3GPP LTE standards.

Or, an indicator indicating whether an EARFCN is an upper bound or a lower bound (i.e., a bound type indicator) may be further included in the IDC indication information. An eNB may determine an unusable frequency band based on the EARFCN and the bound type is indicator.

Or, the type of bound may be implicitly determined based on the number of an operating band to which an EARFCN included in the IDC indication information belongs. For example, in FIG. 16, the bound of the band 7 is an upper bound, and the bound of the band 40 is a lower bound.

For yet another example, the IDC indication information includes an EARFCN. The EARFCN may indicate that an operating band region including the EARFCN is an unusable frequency band. That is, an operating band unit may be indicated by an EARFCN. For example, if an EARFCN corresponding to the lower bound of FIG. 16 is included in information on UE capabilities, an eNB may determine that the band 40 is an unusable frequency band.

For yet another example, if a plurality of operating bands is influenced by a frequency band indicated by the EARFCN, an eNB may determine that all the operating bands are unusable frequency bands. For example, if a frequency indicated by an EARFCN is 2500 MHz, an eNB may determine that both the band 7 and the band 40 including 2500 MHz are unusable bands.

Meanwhile, the information on a TDM pattern may include at least one of a Discontinuous Reception (DRX) cycle, DRX-active duration, and a DRX subframe offset.

The IDC indication information may include information on each unusable frequency band and information on each TDM pattern or may include information on a plurality of unusable frequency bands and information on a plurality of TDM patterns. If the IDC indication information includes information on a plurality of unusable frequency bands and information on a plurality of TDM patterns, the information on an unusable frequency band and the information on a TDM pattern may be paired and transmitted.

After the step S1515, the eNB transmits an RRC connection reconfiguration message to the UE at step S1520. The RRC connection reconfiguration message includes measurement configuration information for configuring measurement to be performed by the UE.

For example, the measurement configuration information may include IDC measurement indication information indicating that measurement related to IDC interference will be performed (hereinafter referred to as ‘IDC measurement indication information’). Here, the IDC measurement indication information may be information indicating that ISM transmission is limited to only a measurement gap in relation to an unusable frequency band.

Furthermore, the IDC measurement indication information may instruct UE to perform measurement including IDC interference, measurement not including IDC interference, or both measurement including IDC interference and measurement not including IDC interference on an unusable frequency band.

Furthermore, the IDC measurement indication information may instruct UE to first measure the strength of IDC interference in relation to an unusable frequency band and then perform measurement including IDC interference or measurement not including IDC interference based on the strength of IDC interference.

Furthermore, the IDC measurement indication information may instruct UE to first measure the intensity and activity of IDC interference in relation to an unusable frequency band and then perform measurement including IDC interference or measurement not including IDC interference based on the intensity and activity of IDC interference.

For another example, the measurement configuration information may include a measurement restriction pattern in addition to IDC measurement indication information. The is measurement restriction pattern may have a DRX pattern form or a bitmap pattern form.

Meanwhile, the IDC measurement indication information may be represented by a report IDC quantity. The report IDC quantity is a new type of a report quantity configuring that measurement report information transmitted from UE to an eNB should include a measurement result related to IDC interference owing to IDC interference-related triggering. More particularly, the report IDC quantity may instruct UE that measurement report information transmitted to an eNB includes a TDM pattern, an unusable frequency band, or an additional measurement result (e.g., an additional report on measurement including IDC interference). The report IDC quantity may be a bitmap indicator. The report IDC quantity may be included in the measurement configuration information entity of an RRC connection reconfiguration message.

After the step S1520, the UE reports a result of the measurement to the eNB according to a rule that measurement samples are obtained at step S1525. The measurement result report may be performed through a measurement report message. For example, information on the measurement result report may be included in a measurement result information element within the measurement report message and transmitted.

The UE may perform measurement including IDC interference or measurement not including IDC interference.

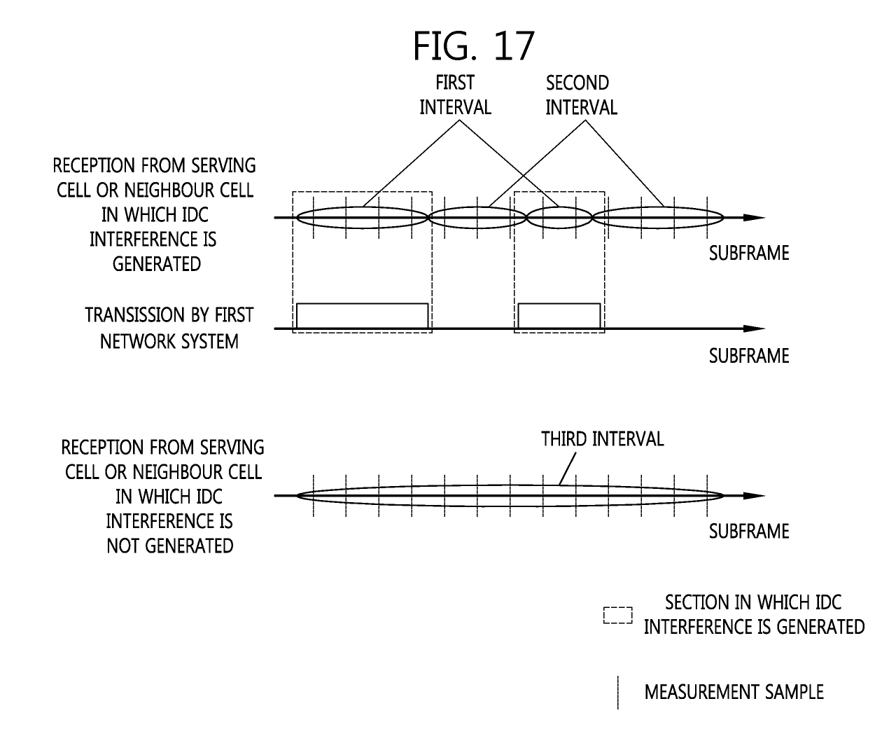

FIG. 17 is a diagram illustrating a UE performing measurement including IDC interference or measurement not including IDC interference according to exemplary embodiments of the present invention.

Referring to FIG. 17, UE calculates a measurement sample including the influence of IDC interference in a interval in which IDC interference in a serving cell or neighboring cell where IDC interference is generated is generated (i.e., a first interval) and is calculates a measurement sample not including the influence of IDC interference in a interval in which IDC interference is not generated (i.e., a second interval). Here, the neighboring cell refers to a cell that is configured by way of an RRC connection reconfiguration process and used as a comparison group of a measurement report event. Furthermore, the UE calculates a measurement sample in the entire interval (i.e., a third interval) irrespective of IDC interference in a serving cell or neighboring cell where IDC interference is not generated. Here, the UE may obtain measurement samples in each subframe, some subframes, or a specific subframe in each interval.

For example, the measurement sample including the influence of IDC interference in the first interval may be a measurement sample in which the influence of interference, including all IDC interference, inter-cell interference (e.g., the interference of co-channel serving and non-serving cells and adjacent channel interference), and thermal noise, has been taken into consideration. The measurement sample not including the influence of IDC interference in the second interval may be a measurement sample including only the influence of inter-cell interference or thermal noise.

Hereinafter, a first network system refers to a network system that provides the influence of interference when IDC interference is generated. A network system attached by interference may be said to be a second network system. For example, when an ISM reception terminal is subject to interference due to LTE uplink, the ISM reception terminal is the second network system. In contrast, when a reception terminal of LTE downlink is subject to interference from an ISM transmission terminal, an LTE system is the second network system.

A measurement sample not including the influence of IDC interference in a neighboring cell that is calculated based on RSRQ may be conceptually represented by Equation 1 below.

MeasurementSample=S/(I+N) Equation 1

In Equation 1, S is the strength of a received signal through a neighboring cell in a second network system, I is the strength of an interference signal (e.g., inter-cell interference) that acts on the second network system, and N is the strength of noise (e.g., thermal noise). That is, a measurement sample means a ratio of a received signal to interference and noise.

A measurement sample not including the influence of IDC interference in a neighboring cell that is calculated based on RSRP may be conceptually represented by Equation 2 below.

MeasurementSample=S Equation 2

In Equation 2, S is the strength of a received signal through a neighboring cell in a second network system. That is, a measurement sample means the strength of a received signal in a corresponding neighboring cell in a second network system.

A measurement sample including the influence of IDC interference in a serving cell that is calculated based on RSRQ may be conceptually represented by Equation 3 below.

MeasurementSample=S/(I+N+I′) Equation 3

In Equation 3, S is the strength of a received signal through a serving cell in a second network system, I is the strength of an interference signal (e.g., inter-cell interference) that acts on the second network system, N is the strength of noise (e.g., thermal noise), and I′ is the strength of IDC interference. That is, a measurement sample means a relative ratio of a is received signal to IDC interference and inter-cell interference.

A measurement sample including the influence of IDC interference in a serving cell that is calculated based on RSRP may be conceptually represented by Equation 4 below.

MeasurementSample=I′,S+I′,S Equation 4

In Equation 4, I′ is the strength of IDC interference, and a measurement sample means the strength of an IDC interference signal in a serving cell. S is the strength of a received signal in a second network system. If only the influence of IDC interference is sought to be measured, I′ may become a result value. If a value including IDC interference is sought to be measured, S+I′ may become a result value. If a value from which IDC interference has been removed is sought to be measured, S may become a result value.

Meanwhile, an entity (e.g., UE) that performs the measurement may be one or plural. For example, an entity that performs measurement including IDC interference and an entity that performs measurement not including IDC interference may exist independently.

A result of measurement including IDC interference and a result of measurement not including IDC interference are described below. In general, a result of measurement means a value finally obtained by filtering measurement samples. For example, in the case of LTE, the final RSRP and the final RSRP value calculated by way of L1 filtering and L3 filtering are measurement results reported to an eNB. A result of measurement including IDC interference may be a result obtained by filtering only measurement samples including IDC interference or a result obtained by filtering both measurement samples including IDC interference and measurement samples not including IDC interference. Furthermore, a result of measurement not including IDC interference may be obtained by filtering only measurement samples not is including IDC interference or may be obtained by filtering measurement samples not including IDC interference and measurement samples obtained by removing IDC interference from measurement samples including IDC interference using an interference removal scheme.

As an exemplary embodiment of the present invention, the measurement report message may include a result of measurement not including IDC interference. UE performs measurement by using measurement samples not including IDC interference.

For another example, the measurement report message may include a result of measurement including IDC interference. UE performs measurement by using measurement samples including IDC interference.

For yet another example, the measurement report message may include both a result of measurement not including IDC interference and a result of measurement including IDC interference. UE performs measurement by using both measurement samples including IDC interference and measurement samples not including IDC interference.

For yet another example, the measurement report message may include both a result of measurement including IDC interference and the strength of IDC interference.

For yet another example, the measurement report message may include both a result of measurement not including IDC interference and the strength of IDC interference.

For yet another example, the measurement report message may include both a result of measurement including IDC interference and the intensity and activity of IDC interference.

For yet another example, the measurement report message may include both a result of measurement not including IDC interference and the intensity and activity of IDC interference.

After the step S1525, the eNB selects the most appropriate ICO scheme based on the measurement report information at step S1530.

The ICO scheme may be an FDM operation or a TDM operation. The FDM operation or the TDM operation may be the operation according to FIGS. 5 to 13.

For example, when there is a problem in a frequency band on which an eNB provides service, if it is determined that a usable frequency band does not have a problem due to load balancing and there is no significant influence on a handover (e.g., when the RSRP or RSRQ value of the frequency band is sufficiently large) based on the measurement report information, the FDM operation may be performed. If not, the TDM operation may be performed in a serving cell.

After the step S1530, the eNB transmits the determined ICO operation to the UE through an RRC connection reconfiguration message at step S1535. The ICO operation is performed in the eNB or the UE based on the RRC connection reconfiguration message.

For example, if the determined ICO operation is an FDM operation, a secondary serving cell may be changed by way of a serving cell management operation (e.g., deleting a problematic secondary serving cell). Or, a handover procedure for changing a primary serving cell may be initiated.

For another example, if the determined ICO operation is a TDM operation, a specific DRX pattern may be transmitted through the RRC connection reconfiguration message.

For yet another example, if the determined ICO operation is a TDM operation, an indicator indicating that a specific DRX pattern is due to IDC interference, together with the DRX pattern, may be transmitted through the RRC connection reconfiguration message. Measurement performed by UE may be changed differently from the measurement at step S1525 is depending on the indication of the indicator.

For yet another example, if the determined ICO operation is a TDM operation, when a signal in an ISM band is transmitted, the retransmission of an HARQ in an LTE band may be denied for the handling of a beacon. That is, the start of the ICO operation may be indicated by IDC indication information.

After the step S1535, the UE triggers an event indicating that on-going IDC state for an unusable frequency band has been terminated (hereinafter referred to as ‘IDC release triggering’) at step S1540. The termination of the on-going IDC state means that there is no difficulty in performing communication because IDC interference is small or infrequently generated in the corresponding frequency band.

For example, if UE has received an IDC triggering release threshold through the RRC connection reconfiguration message (step S1505, S1520, or S1535), IDC release triggering may be performed based on the IDC triggering release threshold.

For another example, if UE has not received an IDC triggering release threshold, IDC release triggering may be performed according to a UE-internal criterion (i.e., UE-internal coordination).

For yet another example, if UE has not received an IDC triggering release threshold, IDC release triggering may be performed based on a predetermined reference value. The predetermined reference value is a value previously determined within a system. The predetermined reference value may be an RSRP value or an RSRQ value. That is, when a measured RSRP or RSRQ value is greater than a predetermined reference value, IDC release triggering is performed. Or, the predetermined reference value may be a value related to the strength of IDC interference. That is, when the strength of measured IDC interference is greater is than a predetermined reference value, IDC release triggering is performed. Or, the predetermined reference value may be a value into which both the intensity and activity of IDC interference are incorporated. That is, when the strength of measured IDC interference is greater than a predetermined reference value and the activity of measured IDC interference is also greater than the predetermined reference value, IDC release triggering is performed.

Meanwhile, the IDC release triggering may be performed only in a serving cell. Or, the IDC release triggering may be performed on all the cells of frequency bands in which a serious IDC interference problem is generated.

After the step S1540, the UE transmits information related to ICO to the eNB by sending IDC indication information to the eNB at step S1545. An IDC indication operation is performed again.

For example, the IDC indication information may include an additional IDC release indicator indicating whether IDC release triggering has been performed or not. The IDC release indicator may be a bitmap indicator. For example, when the IDC release indicator is 0, it indicates that IDC release triggering has not been performed. When the IDC release indicator is 1, it indicates that IDC release triggering has been performed.

If IDC entry triggering has been performed on a plurality of operating bands (or frequency bands) before, an eNB may know that IDC release triggering has been performed on to only a specific operating band (or a frequency band) indicated by the IDC release indicator. That is, an operating band (or a frequency band) on which IDC release triggering has not been performed maintains a state in which IDC entry triggering has been performed.

The IDC entry indicator at step S1515 may be configured so that it is connected to the IDC release indicator at step S1545.

For example, when the IDC entry indicator is ‘1’, it may indicate that IDC entry has been performed. When the IDC release indicator is ‘0’, it may indicate that IDC entry has been released. For another example, when the IDC entry indicator is ‘0’, it may indicate that IDC entry has been performed. When the IDC release indicator is ‘1’, it may indicate that IDC entry has been released. That is, UE may transmit IDC indication/release to an eNB through the IDC entry indicator of one bit.

The corresponding indicator may be set according to an agreement previously made between a network and the UE.

Furthermore, the indicator indicative of IDC entry indication/release may be set to a bit having a length longer than the 1 bit.

For another example, the IDC indication information may include information on an unusable frequency band or information on a TDM pattern. Here, even when the IDC indication information does not include an additional IDC release indicator, an eNB may implicitly determine a situation of IDC interference of UE, such as whether IDC release triggering has been performed or not, based on whether information on an unusable frequency band has been changed or not. That is, if a frequency band included in an unusable frequency band is changed into a state in which the frequency band is not included in the unusable frequency band, an eNB may implicitly determine that IDC release triggering has been performed.

Here, information on the unusable frequency band may be indicated by an EARFCN.

For example, the IDC indication information may include all the EARFCNs of the unusable frequency band.

For another example, the IDC indication information may include an EARFCN corresponding to the bound of the unusable frequency band. The bound may be an upper bound or a lower bound, such as FIG. 16.

That is, if the IDC indication information includes an EARFCN corresponding to the lower bound, an eNB may determine that UE is unable to use a frequency band greater than the lower bound based on the EARFCN. Furthermore, if the IDC indication information includes an EARFCN corresponding to the upper bound, an eNB may determine that UE is unable to use a frequency band greater than the lower bound based on the EARFCN.

Whether an EARFCN included in the IDC indication information is an upper bound or a lower bound may be previously determined according to 3GPP LTE standards.

Or, an indicator indicating whether an EARFCN is an upper bound or a lower bound (i.e., a bound type indicator) may be further included in the IDC indication information. An eNB may determine an unusable frequency band based on the EARFCN and the bound type indicator.

Or, the type of bound may be implicitly determined based on the number of an operating band to which an EARFCN included in the IDC indication information belongs.

For yet another example, an EARFCN included in the IDC indication information may indicate that an operating band region including the EARFCN is an unusable frequency band. That is, the operating band unit may be indicated by the EARFCN.

For yet another example, if a plurality of operating bands is influenced by a frequency band indicated by an EARFCN, an eNB may determine that all the operating bands are unusable bands.

Meanwhile, the information on a TDM pattern may include at least one of a DRX cycle, DRX-active duration, and a DRX subframe offset.

The IDC indication information may include information on each unusable frequency band and information on each TDM pattern or may include information on a plurality of unusable frequency bands and information on a plurality of TDM patterns. If the IDC indication information includes information on a plurality of unusable frequency bands and information on a plurality of TDM patterns, the information on the unusable frequency band and the information on the TDM pattern may be paired and transmitted.

After the step S1545, the eNB transmits an RRC connection reconfiguration message to the UE at step S1550. The RRC connection reconfiguration message includes measurement configuration information for configuring measurement to be performed the UE.

The measurement configuration information may be configured like the measurement configuration information at step S1520. That is, the measurement configuration information may include IDC measurement indication information indicating that measurement related to IDC interference is performed. If the measurement configuration information includes IDC measurement indication information, it may be information configuring that ISM transmission is limited to only a measurement gap in relation to an unusable frequency band. The IDC measurement indication information may instruct UE to perform measurement including IDC interference, measurement not including IDC interference, or both measurement to including IDC interference and measurement not including IDC interference for an unusable frequency band. Furthermore, the IDC measurement indication information may instruct UE to measure the strength of IDC interference for an unusable frequency band and perform measurement including IDC interference (or measurement not including IDC interference) based on the strength of IDC interference. Furthermore, the IDC measurement indication information is may instruct UE to measure the intensity and activity of IDC interference for an unusable frequency band and perform measurement including IDC interference (or measurement not including IDC interference) based on the intensity and activity of IDC interference.

For another example, the measurement configuration information may include a measurement restriction pattern in addition to IDC measurement indication information. The measurement restriction pattern may have a DRX pattern form or a bitmap pattern form. The IDC measurement indication information may be represented by a report IDC quantity. The report IDC quantity may indicate that information on a measurement report transmitted from UE to an eNB includes a TDM pattern, an unusable frequency band, or an additional measurement result (e.g., an additional report for measurement including IDC interference). The report IDC quantity may be a bitmap indicator.

Meanwhile, unlike in the step S1520, the measurement configuration information at step S1550 may include information on a change of at least one of a DRX cycle, DRX-active duration, and a DRX subframe offset or may include information on the release of measurement restriction if there is restriction to measurement.

After the step S1550, the UE performs measurement including IDC interference in a serving cell or neighboring cell in which IDC interference exists or measurement not including IDC interference in a serving cell or neighboring cell in which IDC interference does not exist according to a rule that measurement samples are obtained and transmits information on an updated measurement report to the eNB through a measurement report message at step S1555. Information on an unusable frequency band is information updated after a previous ICO operation, and the measurement report information may further include a release report reporting that the progress of IDC interference for an unusable frequency band has been terminated.

For example, the measurement report message may include a result of measurement not including IDC interference. For another example, the measurement report message may include a result of measurement including IDC interference. For yet another example, the measurement report message may include both a result of measurement not including IDC interference and a result of measurement including IDC interference. For yet another example, the measurement report message may include both a result of measurement including IDC interference and the strength of IDC interference. For yet another example, the measurement report message may include both a result of measurement not including IDC interference and the strength of IDC interference. For yet another example, the measurement report message may include both a result of measurement including IDC interference and the intensity and activity of IDC interference. For yet another example, the measurement report message may include both a result of measurement not including IDC interference and the intensity and activity of IDC interference. Here, an entity (e.g., UE) that performs the measurement may be one or plural.

If an ICO operation is further requested later, the eNB may select the most appropriate ICO scheme based on the updated measurement result and transmit a selected ICO operation to the UE (not shown).

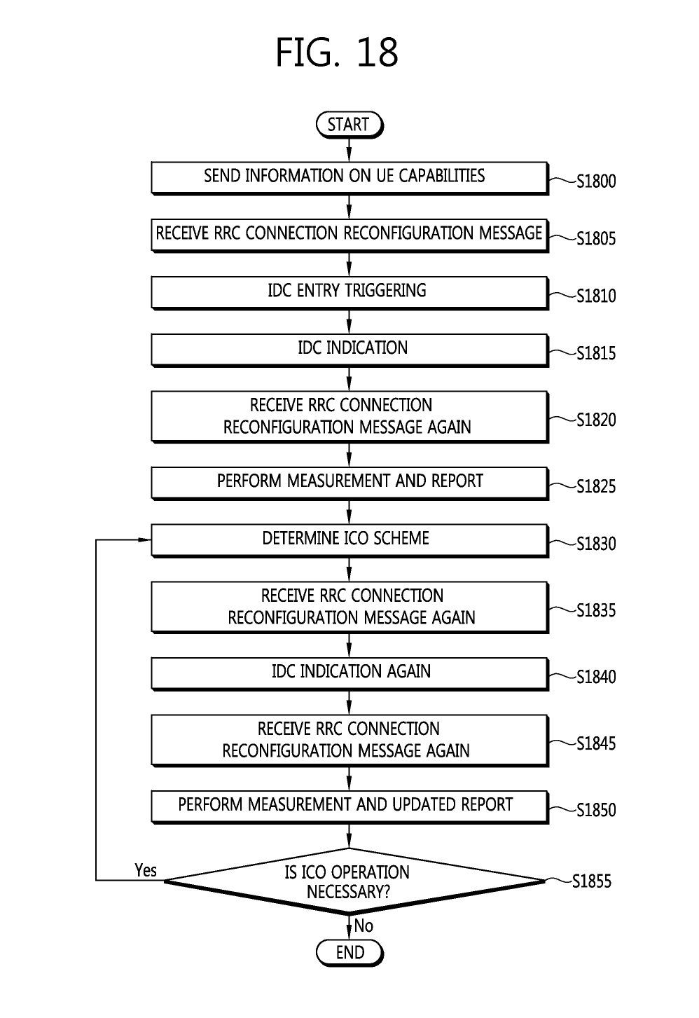

FIG. 18 is a flowchart illustrating an operation of UE that performs an ICO operation according to exemplary embodiments of the present invention.

Referring to FIG. 18, the UE transmits information on UE capabilities to an eNB at step S1800.

The information on UE capabilities may include information on a possibility that IDC interference may exist (e.g., a frequency band including a possibility that IDC interference is may exist, a frequency band not including a possibility that IDC interference may exist, or a frequency band including potential IDC interference existence).

The frequency band including a possibility that IDC interference may exist may be indicated by an EARFCN. For example, the information on UE capabilities may include all the EARFCNs of a frequency band including a possibility that IDC interference may exist or may include an EARFCN corresponding to the bound (i.e., an upper bound or a lower bound) of a frequency band including a possibility that IDC interference may exist. Here, whether the EARFCN is an upper bound or a lower bound may be previously determined according to 3GPP LTE standards or a bound type indicator may be further included in the information on UE capabilities. Or, the type of bound may be implicitly determined based on the number of an operating band to which the EARFCN belongs. Or, the EARFCN may indicate that an operating band region where the EARFCN is placed includes a possibility that IDC interference may exist. For another example, if a plurality of operating bands is influenced by a frequency band indicated by the EARFCN, the EARFCN may indicate that there is a possibility that IDC interference may exist in all the operating bands.

The information on UE capabilities may further include information on the kind or type of another communication system that may generate IDC interference. The information on UE capabilities may further include information on a frequency band that may generate IDC interference in another communication system along with information on the kind or type of another communication system that may generate IDC interference.

The information on UE capabilities may further include an ICO capability indicator indicating whether UE has a capability of performing an ICO operation. For example, the ICO capability indicator may be a bitmap indicator.

For example, a UE capability information message may include a physical layer parameter information entity or a measurement parameter information entity, and the physical layer parameter information entity may include an ICO capability indicator. The ICO capability indicator indicates whether UE has a capability of supporting an ICO operation.

Furthermore, the measurement parameter information entity may include information on a frequency band having an on-going IDC interference possibility in the form of a list. The information on a frequency band may include not only a frequency having an on-going coexistence interference possibility, but also information on a frequency band having potential IDC interference existence.

After the step S1800, the UE receives an RRC connection reconfiguration message from the eNB at step S1805. The RRC connection reconfiguration message includes information for configuring an IDC indication operation.

For example, the RRC connection reconfiguration message may include an IDC triggering threshold. The IDC triggering threshold is an IDC triggering entry threshold or an IDC triggering release threshold. The IDC triggering threshold may be determined based on an RSRP value, an RSRQ value, or the strength of IDC interference or may be determined by taking both the intensity and activity of IDC interference into consideration. Furthermore, the IDC triggering threshold may be differently set for each frequency band or operating band.

Meanwhile, the UE may transmit acknowledgement for the reception of the RRC connection reconfiguration message by sending an RRC reconfiguration completion message to the eNB (not shown).

After the step S1805, the UE performs IDC entry triggering at step S1810.

For example, if the UE has received an IDC triggering entry threshold through an RRC connection reconfiguration message, IDC entry triggering may be performed based on the IDC triggering entry threshold.

For another example, if the UE has not received an IDC triggering entry threshold, IDC entry triggering may be performed according to a UE-internal criterion (i.e., UE-internal coordination).

For another example, if UE does not receive an IDC triggering entry threshold, IDC entry triggering may be performed based on a predetermined reference value.

The predetermined reference value may be an RSRP value or an RSRQ value. That is, when a measured RSRP or RSRQ value is greater than the predetermined reference value, IDC entry triggering is performed.

Or, the predetermined reference value may be a value related to the strength of IDC interference. That is, when the strength of measured IDC interference is greater than the predetermined reference value, IDC entry triggering is performed.

Or, the predetermined reference value may be a value into which both the intensity and activity of IDC interference are incorporated. That is, when the strength of measured IDC interference is greater than a predetermined reference value and the activity of measured IDC interference is greater than the predetermined reference value, IDC entry triggering is performed.

Meanwhile, the IDC entry triggering may be performed only in a serving cell. Or, the IDC entry triggering may be performed in all the cells of frequency bands in which a serious IDC interference problem is generated.

After the step S1810, the UE performs an IDC indication operation for ending information related to ICO by sending IDC indication information to the eNB at step S1815.

The IDC indication information may include an additional IDC entry indicator indicating whether IDC entry triggering has been performed or not. The IDC entry indicator may be a bitmap indicator.

The IDC indication information may include information on an unusable frequency band or information on a TDM pattern. Although the IDC indication information does not include an additional IDC entry indicator, an eNB may implicitly determine a situation of IDC interference of UE, such as IDC entry triggering, based on information on an unusable frequency band.

The information on an unusable frequency band may be indicated by an EARFCN.

For example, the IDC indication information may include all the EARFCNs of the unusable frequency band. For another example, the IDC indication information may include an EARFCN corresponding to the bound (e.g., an upper bound or a lower bound) of the unusable frequency band. Whether the EARFCN included in the IDC indication information is an upper bound or a lower bound may be previously determined according to 3GPP LTE standards, or a bound type indicator may be further included in the IDC indication information. Or, the type of bound may be implicitly determined based on the number of an operating band to which the EARFCN included in the IDC indication information belongs. For yet another example, the IDC indication information includes an EARFCN. The EARFCN may indicate that an operating band region including the EARFCN is an unusable frequency band. For another example, if a plurality of operating bands is influenced by a frequency band indicated by the EARFCN, an eNB may determine that all the operating bands are unusable frequency bands.

Meanwhile, the information on a TDM pattern may include at least one of a DRX cycle, DRX-active duration, and a DRX subframe offset.

The IDC indication information may include information on each unusable frequency band and information on each TDM pattern or may include information on a plurality of unusable frequency bands and information on a plurality of TDM patterns. If the IDC indication information includes information on a plurality of unusable frequency bands and information on a plurality of TDM patterns, the information on an unusable frequency band and the information on a TDM pattern may be paired and transmitted.

After the step S1815, the UE receives an RRC connection reconfiguration message from the eNB at step S1820. The RRC connection reconfiguration message includes measurement configuration information for configuring measurement to be performed by the UE.

For example, the measurement configuration information includes IDC measurement indication information. Here, the measurement configuration information may be information configuring that ISM transmission is limited to only a measurement gap in relation to an unusable frequency band.

Furthermore, the IDC measurement indication information may instruct UE to perform measurement including IDC interference, measurement not including IDC interference, or both measurement including IDC interference and measurement not including IDC to interference for an unusable frequency band.

Furthermore, the IDC measurement indication information may instruct UE to first measure the strength of IDC interference for an unusable frequency band and then perform measurement including IDC interference or measurement not including IDC interference based on the strength of IDC interference.

Furthermore, the IDC measurement indication information may instruct UE to first measure the intensity and activity of IDC interference for an unusable frequency band and then perform measurement including IDC interference or measurement not including IDC interference based on the intensity and activity of IDC interference.

For another example, the measurement configuration information may include not only IDC measurement indication information, but also a measurement restriction pattern. Here, the measurement restriction pattern may have a DRX pattern form or a bitmap pattern form.

Meanwhile, the IDC measurement indication information may be represented by a report IDC quantity. The report IDC quantity may instruct that information on a measurement report transmitted from UE to an eNB includes a TDM pattern, an unusable frequency band, or an additional measurement result (e.g., an additional report on measurement including IDC interference). The report IDC quantity may be a bitmap indicator. The report IDC quantity may be included in the measurement configuration information entity of an RRC connection reconfiguration message.

After the step S1820, the UE performs measurement according to a rule that measurement samples are obtained and reports a result of the measurement to the eNB at step S1825. The measurement result report may be performed through a measurement report message. For example, information on the measurement result report may be included in a measurement result information element within a measurement report message and transmitted.

The UE may perform measurement including IDC interference or measurement not including IDC interference.

The measurement report message may include a result of the measurement not is including IDC interference. The UE performs measurement by using measurement samples not including IDC interference.

For another example, the measurement report message may include a result of the measurement including IDC interference. The UE performs measurement by using measurement samples including IDC interference.

For yet another example, the measurement report message may include both a result of the measurement not including IDC interference and a result of the measurement including IDC interference.

UE performs measurement by using both measurement samples including IDC interference and measurement samples not including IDC interference.

For yet another example, the measurement report message may include both a result of measurement including IDC interference and the strength of IDC interference.

For yet another example, the measurement report message may include both a result of measurement not including IDC interference and the strength of IDC interference.

For yet another example, the measurement report message may include both a result of measurement including IDC interference and the intensity and activity of IDC interference.

For yet another example, the measurement report message may include both a result of measurement not including IDC interference and the intensity and activity of IDC interference.

After the step S1825, the UE receives an ICO operation determined by the eNB by receiving an RRC connection reconfiguration message again at step S1830. The ICO operation is performed in the eNB or the UE based on the RRC connection reconfiguration is message.

For example, if the determined ICO operation is an FDM operation, a secondary serving cell may be changed by way of a serving cell management operation (e.g., deleting a problematic secondary serving cell). Or, a handover procedure for changing a primary serving cell may be initiated.

For another example, if the determined ICO operation is a TDM operation, a specific DRX pattern may be transmitted through the RRC connection reconfiguration message.

For yet another example, if the determined ICO operation is a TDM operation, an indicator indicating that a specific DRX pattern is due to IDC interference, together with the DRX pattern, may be transmitted through the RRC connection reconfiguration message. Measurement performed by UE may be changed differently from the measurement at step S1525 depending on the indication of the indicator.

For yet another example, if the determined ICO operation is a TDM operation, the retransmission of an HARQ in an LTE band may be denied for the handling of a beacon when a signal in an ISM band is transmitted. That is, the start of the ICO operation may be indicated by IDC indication information.

After the step S1830, the UE performs IDC release triggering at step S1835. For example, if the UE has received an IDC triggering release threshold through the RRC connection reconfiguration message, IDC release triggering may be performed based on the IDC triggering release threshold.

For another example, if the UE has not received an IDC triggering release threshold, IDC release triggering may be performed according to a UE-internal criterion (i.e., UE-internal coordination).

For yet another example, if the UE has not received an IDC triggering release threshold, IDC release triggering may be performed based on a predetermined reference value. The predetermined reference value is a value previously determined within a system. The predetermined reference value may be an RSRP value or an RSRQ value. That is, when a measured RSRP or RSRQ value is greater than a predetermined reference value, IDC release triggering is performed. Or, the predetermined reference value may be a value related to the strength of IDC interference. That is, when the strength of measured IDC interference is greater than a predetermined reference value, IDC release triggering is performed. Or, the predetermined reference value may be a value into which both the intensity and activity of IDC interference are incorporated. That is, when the strength of measured IDC interference is greater than a predetermined reference value and the activity of measured IDC interference is also greater than the predetermined reference value, IDC release triggering is performed.

Meanwhile, the IDC release triggering may be performed only in a serving cell. Or, the IDC release triggering may be performed on all the cells of frequency bands in which a serious IDC interference problem is generated.

After the step S1835, the UE performs an IDC indication operation again by sending IDC indication information to the eNB at step S1840.

For example, the IDC indication information may include an additional IDC release indicator indicating whether IDC release triggering has been performed or not. The IDC release indicator may be a bitmap indicator. For example, when the IDC release indicator is 0, it indicates that IDC release triggering has not been performed. When the IDC release indicator is 1, it indicates that IDC release triggering has been performed.

If IDC entry triggering has been performed on a plurality of operating bands (or is frequency bands) before, an eNB may know that the IDC release triggering has been performed on only a specific operating band (or a frequency band) indicated by the IDC release indicator. That is, an operating band (or a frequency band) on which IDC release triggering has not been performed maintains a state in which IDC entry triggering has been performed.

For another example, the IDC indication information may include information on an unusable frequency band or information on a TDM pattern. Here, the IDC indication information may not include an additional IDC release indicator. In this case, an eNB may implicitly determine a situation of IDC interference of UE, such as whether IDC release triggering has been performed or not, based on whether information on an unusable frequency band has been changed or not.

Here, the information on an unusable frequency band may be indicated by an EARFCN.

For example, the IDC indication information may include all the EARFCNs of the unusable frequency band or may include an EARFCN corresponding to the bound (e.g., an upper bound or a lower bound) of the unusable frequency band.

Whether an EARFCN included in the IDC indication information is an upper bound or a lower bound may be previously determined according to 3GPP LTE standards. Or, an indicator indicating whether the EARFCN is an upper bound or a lower bound (i.e., a bound type indicator) may be further included in the IDC indication information. An eNB may determine an unusable frequency band based on the EARFCN and the bound type indicator. Or, the type of bound may be implicitly determined based on the number of an operating band to which an EARFCN included in the IDC indication information belongs.

For yet another example, an EARFCN included in the IDC indication information is may indicate that an operating band region including the EARFCN is an unusable frequency band. That is, an operating band unit may be indicated by the EARFCN. For yet another example, if a plurality of operating bands is influenced by a frequency band indicated by the EARFCN, an eNB may determine that all the operating bands are unusable frequency bands.

Meanwhile, the information on a TDM pattern may include at least one of a DRX cycle, DRX-active duration, and a DRX subframe offset.

The IDC indication information may include information on each unusable frequency band and information on each TDM pattern or may include information on a plurality of unusable frequency bands and information on a plurality of TDM patterns. If the IDC indication information includes information on a plurality of unusable frequency bands and information on a plurality of TDM patterns, the information on an unusable frequency band and the information on a TDM pattern may be paired and transmitted.

After the step S1840, the UE receives an RRC connection reconfiguration message from the eNB again at step S1845. The RRC connection reconfiguration message includes measurement configuration information for configuring measurement to be performed by the UE.

The measurement configuration information may include IDC measurement indication information indicating that measurement related to IDC interference is performed. If the measurement configuration information includes IDC measurement indication information, it may be information configuring that ISM transmission is limited to only a measurement gap in relation to an unusable frequency band. The IDC measurement indication information may instruct the UE to perform measurement including IDC interference, measurement not including IDC interference, or both measurement including IDC interference and measurement not is including IDC interference for an unusable frequency band. Furthermore, the IDC measurement indication information may instruct UE to measure the strength of IDC interference for an unusable frequency band and perform measurement including IDC interference (or measurement not including IDC interference) based on the strength of IDC interference. Furthermore, the IDC measurement indication information may instruct UE to measure the intensity and activity of IDC interference for an unusable frequency band and perform measurement including IDC interference (or measurement not including IDC interference) based on the intensity and activity of IDC interference.

For another example, the measurement configuration information may include a measurement restriction pattern in addition to IDC measurement indication information. The measurement restriction pattern may have a DRX pattern form or a bitmap pattern form. The IDC measurement indication information may be represented by a report IDC quantity. The report IDC quantity may indicate that information on a measurement report transmitted from UE to an eNB includes a TDM pattern, an unusable frequency band, or an additional measurement result (e.g., an additional report for measurement including IDC interference). The report IDC quantity may be a bitmap indicator. The report IDC quantity may be included in the measurement configuration information entity of an RRC connection reconfiguration message.

Meanwhile, the measurement configuration information may include information on a change of at least one of a DRX cycle, DRX-active duration, and a DRX subframe offset or may include information on the release of measurement restriction if there is restriction to measurement.

After the step S1845, the UE performs measurement including IDC interference in a serving cell or neighboring cell in which IDC interference exists or measurement not is including IDC interference in a serving cell or neighboring cell in which IDC interference does not exist according to a rule that measurement samples are obtained and transmits information on an updated measurement report to the eNB through a measurement report message at step S1850. Information on an unusable frequency band is information updated after a previous ICO operation, and the measurement report information may further include a release report reporting that the progress of IDC interference for an unusable frequency band has been terminated.

For example, the measurement report message may include a result of measurement not including IDC interference. For another example, the measurement report message may include a result of measurement including IDC interference. For yet another example, the measurement report message may include both a result of measurement not including IDC interference and a result of measurement including IDC interference. For yet another example, the measurement report message may include both a result of measurement including IDC interference and the strength of IDC interference. For yet another example, the measurement report message may include both a result of measurement not including IDC interference and the strength of IDC interference. For yet another example, the measurement report message may include both a result of measurement including IDC interference and the intensity and activity of IDC interference. For yet another example, the measurement report message may include both a result of measurement not including IDC interference and the intensity and activity of IDC interference. Here, an entity (e.g., UE) that performs the measurement may be one or plural.

After the step S1850, if another ICO operation is determined to be further requested at step S1855, when the eNB selects the most appropriate ICO scheme based on the updated measurement result, the UE receives an RRC connection reconfiguration message from is the eNB again at step S1830, performs IDC release triggering at step S1835, and indicates IDC interference again.

If another ICO operation is determined not to be required at step S1855, the ICO operation of the UE is terminated.

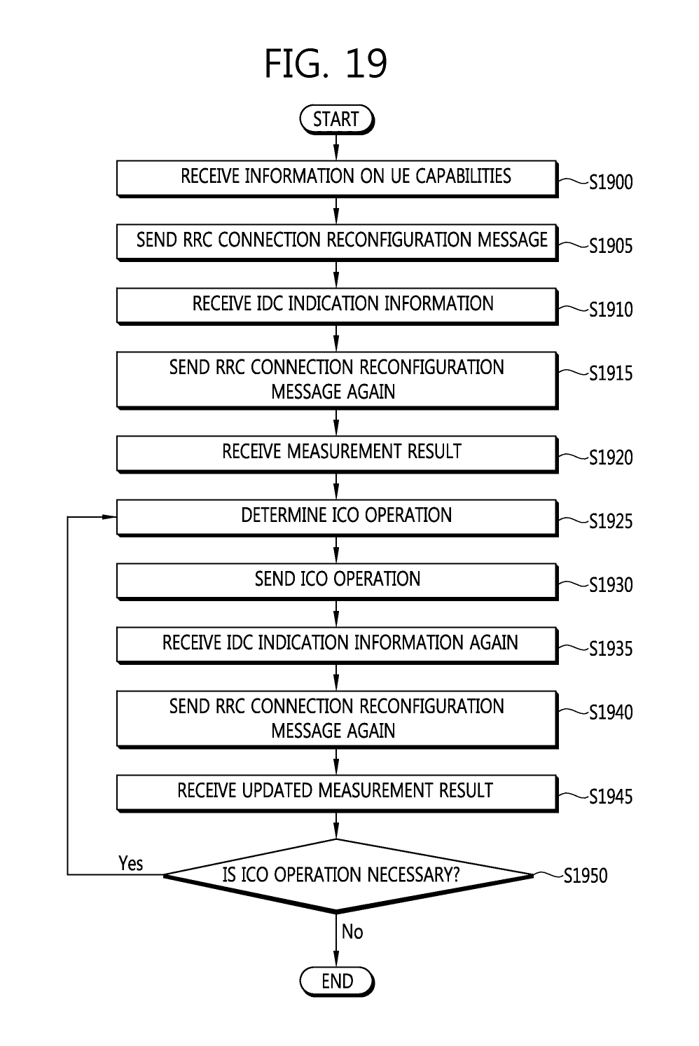

FIG. 19 is a flowchart illustrating an operation of an eNB which performs an ICO operation according to exemplary embodiments of the present invention.

Referring to FIG. 19, the eNB receives information on UE capabilities from the UE at step S1900.

The information on UE capabilities may include information on a possibility that IDC interference may exist (e.g., a frequency band including a possibility that IDC interference may exist, a frequency band not including a possibility that IDC interference may exist, or a frequency band including potential IDC interference existence).

The frequency band including a possibility that IDC interference may exist may be indicated by an EARFCN. For example, the information on UE capabilities may include all the EARFCNs of a frequency band including a possibility that IDC interference may exist or may include an EARFCN corresponding to the bound (i.e., an upper bound or a lower bound) of a frequency band including a possibility that IDC interference may exist. Here, whether an EARFCN included in the information on UE capabilities is an upper bound or a lower bound to may be previously determined according to 3GPP LTE standards or an indicator indicating whether the EARFCN is an upper bound or a lower bound (i.e., a bound type indicator) may be further included in the information on UE capabilities. Or, the type of bound may be implicitly determined based on the number of an operating band to which the EARFCN included in the information on UE capabilities belongs. For another example, the information on UE is capabilities may include an EARFCN, and the EARFCN may indicate that an operating band region itself where the EARFCN is placed includes a possibility that IDC interference may exist. For yet another example, if a plurality of operating bands is influenced by a frequency band indicated by the EARFCN, an eNB may determine that there is a possibility that IDC interference may exist in all the operating bands.

The information on UE capabilities may further include information on the kind or type of another communication system that may generate IDC interference. The information on UE capabilities may further include information on a frequency band that may generate IDC interference in another communication system along with information on the kind or type of another communication system that may generate IDC interference.

The information on UE capabilities may further include an ICO capability indicator. If the ICO capability indicator indicates that UE does not have a capability of performing an ICO operation, an eNB may determine that it is not necessary to transmit information related to ICO to the UE. For example, the ICO capability indicator may be a bitmap indicator.

After the step S1900, the eNB transmits an RRC connection reconfiguration message to the UE at step S1905. The RRC connection reconfiguration message includes information for configuring an IDC indication operation.

For example, the RRC connection reconfiguration message may include an IDC triggering threshold. The IDC triggering threshold is an IDC triggering entry threshold or an IDC triggering release threshold. The IDC triggering threshold may be determined based on an RSRP value, an RSRQ value, or the strength of IDC interference or may be determined by taking both the intensity and activity of IDC interference into consideration. Furthermore, the IDC triggering threshold may be differently set for each frequency band or operating band.

Meanwhile, the eNB may receive acknowledgement for the reception of the RRC connection reconfiguration message by receiving an RRC reconfiguration completion message from the UE (not shown).

After the step S1905, the eNB receives information related to ICO from the UE through IDC indication information at step S1910.

The IDC indication information may include an additional IDC entry indicator indicating whether IDC entry triggering has been performed or not. The IDC entry indicator may be a bitmap indicator.

The IDC indication information may include information on an unusable frequency band or information on a TDM pattern. Although the IDC indication information does not include an additional IDC entry indicator, the eNB may implicitly determine a situation of IDC interference of the UE, such as IDC entry triggering, based on information on an unusable frequency band.

The information on an unusable frequency band may be indicated by an EARFCN.

For example, the IDC indication information may include all the EARFCNs of the unusable frequency band or may include an EARFCN corresponding to the bound (e.g., an upper to bound or a lower bound) of the unusable frequency band. Whether the EARFCN included in the IDC indication information is an upper bound or a lower bound may be previously determined according to 3GPP LTE standards, or a bound type indicator may be further included in the IDC indication information. Or, the type of bound may be implicitly determined based on the number of an operating band to which the EARFCN included in the IDC indication is information belongs. For another example, the IDC indication information includes an EARFCN. The EARFCN may indicate that an operating band region including the EARFCN is an unusable frequency band. For yet another example, if a plurality of operating bands is influenced by a frequency band indicated by the EARFCN, an eNB may determine that all the operating bands are unusable frequency bands.

Meanwhile, the information on a TDM pattern may include at least one of a DRX cycle, DRX-active duration, and a DRX subframe offset.

The IDC indication information may include information on each unusable frequency band and information on each TDM pattern or may include information on a plurality of unusable frequency bands and information on a plurality of TDM patterns. If the IDC indication information includes information on a plurality of unusable frequency bands and information on a plurality of TDM patterns, the information on an unusable frequency band and the information on a TDM pattern may be paired and transmitted.

After the step S1910, the eNB transmits an RRC connection reconfiguration message to the UE at step S1915. The RRC connection reconfiguration message includes measurement configuration information for configuring measurement to be performed by the UE.

For example, the measurement configuration information includes IDC measurement indication information. Here, the measurement configuration information may be information configuring that ISM transmission is limited to only a measurement gap in relation to an unusable frequency band.

Furthermore, the IDC measurement indication information may instruct UE to perform measurement including IDC interference, measurement not including IDC interference, is or both measurement including IDC interference and measurement not including IDC interference for an unusable frequency band.

Furthermore, the IDC measurement indication information may instruct UE to first measure the strength of IDC interference for an unusable frequency band and then perform measurement including IDC interference or measurement not including IDC interference based on the strength of IDC interference.

Furthermore, the IDC measurement indication information may instruct UE to first measure the intensity and activity of IDC interference for an unusable frequency band and then perform measurement including IDC interference or measurement not including IDC interference based on the intensity and activity of IDC interference.

For another example, the measurement configuration information may include not only IDC measurement indication information, but also a measurement restriction pattern. Here, the measurement restriction pattern may have a DRX pattern form or a bitmap pattern form.

After the step S1915, the eNB receives a result of the measurement from the UE at step S1920. A measurement result report may be received through a measurement report message. For example, information on the measurement result report may be included in a measurement result information element within the measurement report message and transmitted.

The measurement report message may include a result of measurement not including IDC interference. The result of the measurement not including IDC interference is a result of measurement performed by the UE using measurement samples not including IDC interference.

For another example, the measurement report message may include a result of measurement including IDC interference. The result of the measurement including IDC interference is a result of measurement performed by the UE using measurement samples including IDC interference.

For yet another example, the measurement report message may include both a result of measurement not including IDC interference and a result of measurement including IDC interference. The result of the measurement not including IDC interference and the result of the measurement including IDC interference are results of measurement performed by the UE using both measurement samples including IDC interference and measurement samples not including IDC interference.

For yet another example, the measurement report message may include both a result of measurement including IDC interference and the strength of IDC interference.

For yet another example, the measurement report message may include both a result of measurement not including IDC interference and the strength of IDC interference.

For yet another example, the measurement report message may include both a result of measurement including IDC interference and the intensity and activity of IDC interference.

For yet another example, the measurement report message may include both a result of measurement not including IDC interference and the intensity and activity of IDC interference.

After the step S1920, the eNB determines the most appropriate ICO scheme based on the information on the measurement result report at step S1925.

Here, the ICO scheme may be an FDM operation or a TDM operation. The FDM is operation or the TDM operation may be an operation according to FIGS. 5 to 13.

For example, the eNB may determine the ICO scheme so that the FDM operation is performed if it is determined that a usable frequency band does not have a problem due to load balancing and there is no significant influence on a handover (e.g., when the RSRP or RSRQ value of the frequency band is sufficiently large) based on the information on the measurement result report when there is a problem in the frequency band on which the eNB provides service and the TDM operation is performed in a serving cell if not.

After the step S1925, the eNB transmits the ICO operation, determined based on the RRC connection reconfiguration message, to the UE at step S1930. The ICO operation is performed in the eNB or the UE based on the RRC connection reconfiguration message.

For example, if the determined ICO operation is an FDM operation, a secondary serving cell may be changed by way of a serving cell management operation (e.g., deleting a problematic secondary serving cell). Or, a handover procedure for changing a primary serving cell may be initiated.

For another example, if the determined ICO operation is a TDM operation, a specific DRX pattern may be transmitted through the RRC connection reconfiguration message.

For yet another example, if the determined ICO operation is a TDM operation, an indicator indicating that a specific DRX pattern is due to IDC interference, together with the DRX pattern, may be transmitted through the RRC connection reconfiguration message. Measurement performed by the UE may be changed differently from the measurement at step S1525 depending on the indication of the indicator.

For yet another example, if the determined ICO operation is a TDM operation, when a signal in an ISM band is transmitted, the retransmission of an HARQ in an LTE band is may be denied for the handling of a beacon. That is, the start of the ICO operation may be indicated by IDC indication information.

After the step S1930, the eNB receives IDC indication information from the UE again at step S1935.

For example, the IDC indication information may include an additional IDC release indicator indicating whether IDC release triggering has been performed or not. The IDC release indicator may be a bitmap indicator. For example, when the IDC release indicator is 0, it indicates that IDC release triggering has not been performed. When the IDC release indicator is 1, it indicates that IDC release triggering has been performed.

If IDC entry triggering has been performed on a plurality of operating bands (or frequency bands) before, an eNB may know that the IDC release triggering has been performed on only a specific operating band (or a frequency band) indicated by the IDC release indicator. That is, an operating band (or a frequency band) on which IDC release triggering has not been performed maintains a state in which IDC entry triggering has been performed.

For another example, the IDC indication information may include information on an unusable frequency band or information on a TDM pattern. Here, even when the IDC indication information does not include an additional IDC release indicator, an eNB may implicitly determine a situation of IDC interference of UE, such as whether IDC release to triggering has been performed or not, based on whether information on an unusable frequency band has been changed or not. That is, if a frequency band included in an unusable frequency band is changed into a state in which the frequency band is not included in the unusable frequency band, an eNB may implicitly determine that IDC release triggering has been performed.

Here, the information on the unusable frequency band may be indicated by an EARFCN.

For example, the IDC indication information may include all the EARFCNs of the unusable frequency band or may include an EARFCN corresponding to the bound (e.g., an upper bound or a lower bound) of the unusable frequency band. That is, if the IDC indication information includes an EARFCN corresponding to the lower bound, an eNB may determine that UE is unable to use a frequency band greater than the lower bound based on the EARFCN. Furthermore, if the IDC indication information includes an EARFCN corresponding to the upper bound, an eNB may determine that UE is unable to use a frequency band greater than the lower bound based on the EARFCN.

Whether an EARFCN included in the IDC indication information is an upper bound or a lower bound may be previously determined according to 3GPP LTE standards. Or, an indicator indicating whether an EARFCN is an upper bound or a lower bound (i.e., a bound type indicator) may be further included in the IDC indication information. An eNB may determine an unusable frequency band based on the EARFCN and the bound type indicator. Or, the type of bound may be implicitly determined based on the number of an operating band to which an EARFCN included in the IDC indication information belongs.

For yet another example, an EARFCN included in the IDC indication information may indicate that an operating band region including the EARFCN is an unusable frequency band. That is, the operating band unit may be indicated by the EARFCN.

For yet another example, if a plurality of operating bands is influenced by a frequency band indicated by the EARFCN, an eNB may determine that all the operating bands are unusable frequency bands.

Meanwhile, the information on a TDM pattern may include at least one of a DRX cycle, DRX-active duration, and a DRX subframe offset.

The IDC indication information may include information on each unusable frequency band and information on each TDM pattern or may include information on a plurality of unusable frequency bands and information on a plurality of TDM patterns. If the IDC indication information includes information on a plurality of unusable frequency bands and information on a plurality of TDM patterns, the information on the unusable frequency band and the information on the TDM pattern may be paired and transmitted.

After the step S1935, the eNB transmits an RRC connection reconfiguration message to the UE again at step S1940. The RRC connection reconfiguration message includes measurement configuration information for configuring measurement to be performed by the UE.

The measurement configuration information may include IDC measurement indication information indicating that measurement related to IDC interference is performed. If the measurement configuration information includes IDC measurement indication information, it may be information configuring that ISM transmission is limited to only a measurement gap in relation to an unusable frequency band. The IDC measurement indication information may instruct the UE to perform measurement including IDC interference, measurement not including IDC interference, or both measurement including IDC interference and measurement not including IDC interference on an unusable frequency band. Furthermore, the IDC measurement indication information may instruct UE to measure the strength of IDC interference for an unusable frequency band and perform measurement including IDC interference (or measurement not including IDC interference) based on the strength of IDC interference. Furthermore, the IDC measurement indication information may instruct UE to measure the intensity and activity of IDC interference for an unusable frequency band and perform measurement including IDC interference (or measurement not including IDC interference) based on the intensity and activity of IDC interference.

For another example, the measurement configuration information may include a measurement restriction pattern in addition to IDC measurement indication information. The measurement restriction pattern may have a DRX pattern form or a bitmap pattern form. The IDC measurement indication information may be represented by a report IDC quantity. The report IDC quantity may indicate that information on a measurement report transmitted from UE to an eNB includes a TDM pattern, an unusable frequency band, or an additional measurement result (e.g., an additional report for measurement including IDC interference). The report IDC quantity may be a bitmap indicator.

Meanwhile, the measurement configuration information may include information on a change of at least one of a DRX cycle, DRX-active duration, and a DRX subframe offset or may include information on the release of measurement restriction if there is restriction to measurement.

After the step S1940, the eNB receives information on a measurement result report, updated by the UE performing measurement including IDC interference or measurement not including IDC interference according to a rule that measurement samples are obtained, from the UE through a measurement report message at step S1945. The information on an unusable frequency band is information updated after the ICO operation previously performed, and the information on the measurement result report may further include a release report reporting that the progress of IDC interference on an unusable frequency band has been terminated.

For example, the measurement report message may include a result of measurement not including IDC interference. For another example, the measurement report message may include a result of measurement including IDC interference. For yet another example, the measurement report message may include both a result of measurement not including IDC interference and a result of measurement including IDC interference. For yet another example, the measurement report message may include both a result of measurement including IDC interference and the strength of IDC interference. For yet another example, the measurement report message may include both a result of measurement not including IDC interference and the strength of IDC interference. For yet another example, the measurement report message may include both a result of measurement including IDC interference and the intensity and activity of IDC interference. For yet another example, the measurement report message may include both a result of measurement not including IDC interference and the intensity and activity of IDC interference. Here, an entity (e.g., UE) that performs the measurement may be one or plural.

After the step S1945, if an ICO operation is determined to be further requested at step S1950, the eNB selects the most appropriate ICO scheme based on the updated measurement result at step S1925 and transmits an RRC connection reconfiguration message to the UE again at step S1930.

If an ICO operation is determined not to be further requested at step S1950, the ICO operation of the eNB is terminated.

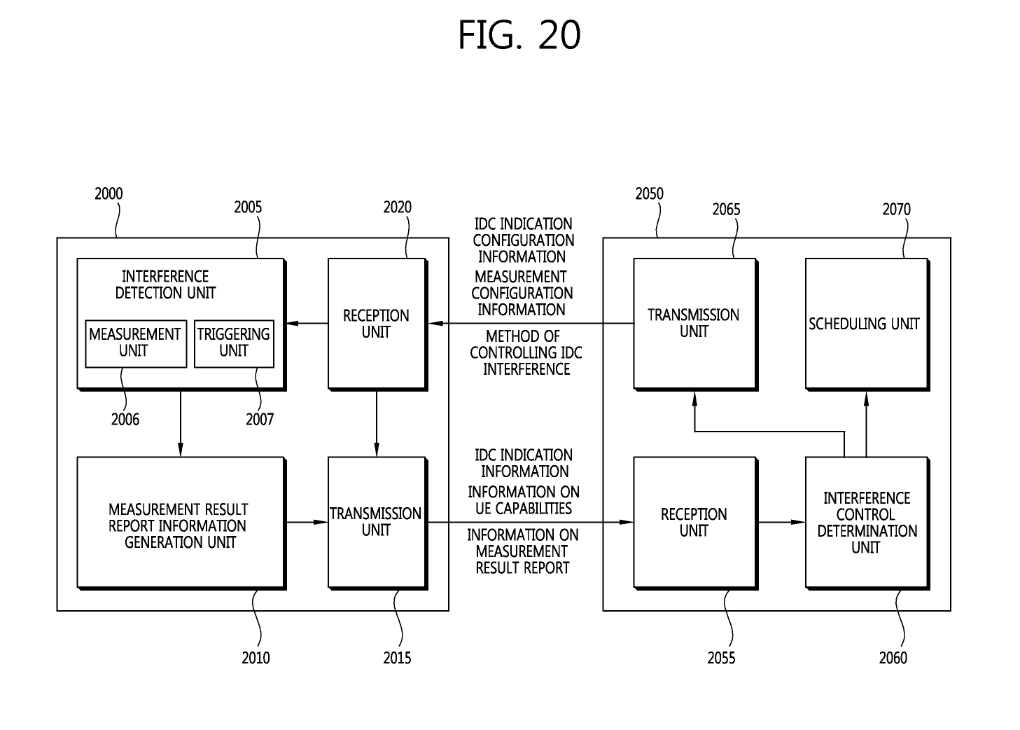

FIG. 20 is a block diagram illustrating an apparatus for transmitting and receiving information on IDC interference according to exemplary embodiments of the present invention.

Referring to FIG. 20, UE 2000 and an eNB 2050 exchange pieces of information is on IDC interference.

The UE 2000 includes an interference detection unit 2005, a measurement result report information generation unit 2010, a transmission unit 2015, and a reception unit 2020.

The interference detection unit 2005 detects the occurrence of IDC interference. For example, while the UE 2000 receives a signal x from the eNB 2050 through an LTE RF, the UE 200 detects the occurrence of IDC interference when it sends a signal y through another RF, such as Wi-Fi.

The interference detection unit 2005 includes a measurement unit 2006 and a triggering unit 2007.

The measurement unit 2006 performs measurement including IDC interference and measurement not including IDC interference. The measurement unit 2006 distinguishes a part with the influence of IDC interference and a part without the influence of IDC interference and performs measurement using measurement samples.

The triggering unit 2007 may perform triggering (i.e., IDC entry triggering or IDC release triggering) based on an RRC connection reconfiguration message (or IDC indication configuration information) received from the eNB. For example, if the UE has received an IDC triggering entry threshold through the RRC connection reconfiguration message, the triggering unit 2007 performs IDC entry triggering based on the IDC triggering entry threshold. For another example, if the UE has not received an IDC triggering entry threshold, the triggering unit 2007 may perform IDC entry triggering according to a UE-internal criterion (i.e., UE-internal coordination) or may perform IDC entry triggering based on a predetermined reference value. Here, the predetermined reference value may be an RSRP value or an RSRQ value, a value related to the strength of IDC interference, or a value into which both the intensity and activity of IDC interference are incorporated. Meanwhile, the IDC entry triggering may be performed only in a serving cell or may be performed on all the cells of frequency bands in which a serious IDC interference problem is generated.

The measurement result report information generation unit 2010 generates information on a measurement result report. When the measurement result is updated, the measurement result report information generation unit 2010 generates information on the updated measurement result report. The information on the measurement result report may include a result of measurement not including IDC interference, a result of measurement including IDC interference, or both a result of measurement not including IDC interference and a result of measurement including IDC interference. For another example, the information on the measurement result report may include both a result of measurement including IDC interference and the strength of IDC interference, both a result of measurement not including IDC interference and the strength of IDC interference, both a result of measurement including IDC interference and the intensity and activity of IDC interference, or both a result of measurement not including IDC interference and the intensity and activity of IDC interference.

The transmission unit 2015 transmits information on UE capabilities to the eNB. The information on UE capabilities may include information on a possibility that IDC interference may exist (e.g., a frequency band including a possibility that IDC interference may exist, a frequency band not including a possibility that IDC interference may exist, or a frequency band including potential IDC interference existence). The frequency band including a possibility that IDC interference may exist may be indicated by an EARFCN. The information on UE capabilities may further include information on the kind or type of another communication system that may generate IDC interference and information on a frequency band is that may generate IDC interference in another communication system. The information on UE capabilities may further include an ICO capability indicator indicating whether UE has a capability of performing ICO or not.

The transmission unit 2015 transmits IDC indication information to the eNB 2050. The IDC indication information may include an additional IDC entry indicator indicating whether IDC entry triggering has been performed or not. The IDC indication information may include information on an unusable frequency band or information on a TDM pattern. The information on an unusable frequency band may be indicated by an EARFCN. The IDC indication information may include all the EARFCNs of the unusable frequency band or an EARFCN corresponding to the bound (e.g., an upper bound or a lower bound) of the unusable frequency band. Whether the EARFCN included in the IDC indication information is an upper bound or a lower bound may be previously determined according to 3GPP LTE standards, or a bound type indicator may be further included in the IDC indication information. Meanwhile, the information on a TDM pattern may include at least one of a DRX cycle, DRX-active duration, and a DRX subframe offset. The IDC indication information may include information on each unusable frequency band and information on each TDM pattern or information on a plurality of unusable frequency bands and information on a plurality of TDM patterns. The information on an unusable frequency band and the information on a TDM pattern may be paired and transmitted.

The transmission unit 2015 includes information on the measurement result report in a measurement result information element within the measurement report message and transmits the measurement report message. If information on the measurement result report is updated, the transmission unit 2015 transmits information on the updated measurement result is report to the eNB 2050 again.

The reception unit 2020 receives IDC indication configuration information from the eNB 2050 through an RRC connection reconfiguration message. The IDC indication configuration information is information for configuring an IDC indication operation. For example, the RRC connection reconfiguration message includes an IDC triggering threshold (e.g., an IDC triggering entry threshold or an IDC triggering release threshold). The IDC triggering threshold may be determined based on an RSRP value, an RSRQ value, or the strength of IDC interference or may be determined by taking both the intensity and activity of IDC interference into consideration. Furthermore, the IDC triggering threshold may be set differently for each frequency band or each operating band.

The reception unit 2020 receives measurement configuration information from the eNB 2050 through an RRC connection reconfiguration message. The measurement configuration information includes IDC measurement indication information. The measurement configuration information may be information configuring that ISM transmission is limited to only a measurement gap in relation to an unusable frequency band. Furthermore, the IDC measurement indication information may instruct the UE to perform measurement including IDC interference, measurement not including IDC interference, or both measurement including IDC interference and measurement not including IDC interference on an unusable frequency band. Furthermore, the IDC measurement indication information may instruct the UE to first measure the strength of IDC interference for an unusable frequency band and then perform measurement including IDC interference or measurement not including IDC interference based on the strength of IDC interference. Furthermore, the IDC measurement indication information may instruct the UE to first measure the intensity and activity of IDC interference for an unusable frequency is band and then perform measurement including IDC interference or measurement not including IDC interference based on the intensity and activity of IDC interference. For another example, the measurement configuration information may include a measurement restriction pattern in addition to IDC measurement indication information. The measurement restriction pattern may have a DRX pattern form or a bitmap pattern form. The IDC measurement indication information may be represented by a report IDC quantity.

The reception unit 2020 receives an RRC connection reconfiguration message, including an ICO operation determined by the eNB 2050, from the eNB 2050.

The eNB 2050 includes a reception unit 2055, an interference control determination unit 2060, a transmission unit 2065, and a scheduling unit 2070.

The reception unit 2055 receives information on UE capabilities from the UE 2000. The information on UE capabilities may include information on a possibility that IDC interference may exist (e.g., a frequency band including a possibility that IDC interference may exist, a frequency band not including a possibility that IDC interference may exist, or a frequency band including potential IDC interference existence).

The reception unit 2055 receives IDC indication information from the UE 2000. The IDC indication information may include an additional IDC entry indicator indicating whether IDC entry triggering has been performed or not. The IDC indication information may to include information on an unusable frequency band or information on a TDM pattern. The information on an unusable frequency band may be indicated by an EARFCN. The information on a TDM pattern may include at least one of a DRX cycle, DRX-active duration, and a DRX subframe offset.

The reception unit 2055 receives a result of measurement performed by the UE. The measurement result report may receive the result of the measurement through a measurement report message. For example, information on the measurement result report may be included in a measurement result information element within the measurement report message and transmitted.

The interference control determination unit 2060 determines an ICO operation based on measurement report information received from the UE 2000. The ICO operation may be an FDM operation or a TDM operation. Furthermore, the FDM operation or the TDM operation may be an operation according to FIGS. 5 to 13.

The transmission unit 2065 transmits an RRC connection reconfiguration message, including IDC indication configuration information for configuring the IDC indication operation of the UE 2000, to the UE 2000. The RRC connection reconfiguration message includes an IDC triggering threshold.

The transmission unit 2065 transmits an RRC connection reconfiguration message, including measurement configuration information for configuring measurement to be performed by the UE 2000, to the UE 2000.

The transmission unit 2065 transmits the ICO operation determined by the interference control determination unit 2060 to the UE 2000.

The scheduling unit 2070 performs the ICO operation in an FDM operation or a TDM operation based on a determination made by the interference control determination unit 2060. The FDM operation may be performed by way of an RRC connection reconfiguration. The TDM operation may be performed by indicating a TDM pattern or by way of a DRX reconfiguration.

The eNB 2050 may further include a measurement configuration information is generation unit (not shown) for generating measurement configuration information for configuring measurement to be performed by the UE 2000.

The above description is only an example of the technical spirit of the present invention, and those skilled in the art may change and modify the present invention in various ways without departing from the intrinsic characteristic of the present invention. Accordingly, the disclosed embodiments should not be construed as limiting the technical spirit of the present invention, but should be construed as illustrating the technical spirit of the present invention. The scope of the technical spirit of the present invention is not restricted by the embodiments, and the scope of the present invention should be interpreted based on the appended claims. Accordingly, the present invention should be construed as covering all modifications or variations induced from the meaning and scope of the appended claims and their equivalents.

What is claimed is:

1. A method for controlling In-Device Coexistence interference (IDC) by a User Equipment (UE) in a wireless communication system, the method comprising:
transmitting, to a base station (BS), UE capability information of whether the UE has a capability to control IDC;
receiving, from the BS, IDC indication configuration information of whether the IDC is on-going; and
transmitting, to the BS, a measurement result in consideration of IDC or a measurement result without consideration of IDC and IDC indication based on the IDC indication configuration information.

2. The method of claim 1, wherein the IDC indication comprises an IDC entry indicator indicating whether the IDC entry triggering, which triggers an event representing IDC on-going situation starts, has been performed, and an IDC release indicator indicating whether the IDC release triggering, which triggers an event representing IDC on-going situation ends, has been performed.

3. The method of claim 2, wherein the IDC entry indicator and the IDC release indicator are configured to be connected.

4. The method of claim 3, wherein if the IDC entry indicator is 1, the IDC release indicator is configured to 0, but if the IDC release indicator is 0, the IDC release indicator is configured to 1.

5. The method of claim 1, wherein the UE capability information is 1 bit indicator indicating whether the UE has capabilities to control IDC interference; and
if the 1 bit indicator is 0, the 1 bit indicator indicates that the UE does not have capabilities to control IDC interference, but if the 1 bit indicator is 1, the 1 bit indicator indicates that the UE has capabilities to control IDC interference.

6. The method of claim 1, wherein the UE capability information includes a list including a frequency band in which IDC on-going is possible or a frequency band in which potential IDC interference exists.

7. A user equipment (UE) for controlling In-Device Coexistence interference (IDC) in a wireless communication system, the UE comprising:
transmitting unit transmitting, to a base station (BS), UE capability information of whether the UE has a capability to control IDC; and
receiving unit receiving, from the BS, IDC indication configuration information of whether the IDC is on-going;
wherein the transmitting unit transmits, to the BS, a measurement result in consideration of IDC or a measurement result without consideration of IDC and IDC indication based on the IDC indication configuration information.

8. The UE of claim 7, wherein the transmitting unit transmits the IDC indication comprising an IDC entry indicator indicating whether the IDC entry triggering, which triggers an event representing IDC on-going situation starts, has been performed and an IDC release indicator indicating whether the IDC release triggering, which triggers a event representing IDC on-going situation ends, has been performed.

9. The UE of claim 8, wherein the IDC entry indicator and the IDC release indicator are configured to be connected.

10. The UE of claim 9, wherein if the IDC entry indicator is 1, the IDC release indicator is configured to 0, but if the IDC release indicator is 0, the IDC release indicator is configured to 1.

11. The UE of claim 7, wherein the UE capability information is 1 bit indicator indicating whether the UE has capabilities to control IDC interference; and
if the 1 bit indicator is 0, the 1 bit indicator indicates that the UE does not have capabilities to control IDC interference, but if the 1 bit indicator is 1, the 1 bit indicator indicates that the UE has capabilities to control IDC interference.

12. The UE of claim 7, wherein the UE capability information includes a list including a frequency band in which IDC on-going is possible or a frequency band in which potential IDC interference exists.

13. A method for controlling In-Device Coexistence interference (IDC) by a Base Station (BS) in a wireless communication system, the method comprising:
receiving, from a User Equipment (UE), UE capability information of whether the UE has a capability to control IDC;
transmitting, to the UE, IDC indication configuration information whether the IDC is on-going; and
receiving, from the UE, a measurement result in consideration of IDC or a measurement result without consideration of IDC and IDC indication based on the IDC indication configuration information.

14. The method of claim 13, wherein the IDC indication comprises an IDC entry indicator indicating whether the IDC entry triggering, which triggers an event representing IDC on-going situation starts, has been performed and an IDC release indicator indicating whether the IDC release triggering, which triggers a event representing IDC on-going situation ends, has been performed.

15. The method of claim 14, wherein the IDC entry indicator and the IDC release indicator are configured to be connected.

16. The method of claim 15, wherein if the IDC entry indicator is 1, the IDC release indicator is configured to 0, but if the IDC release indicator is 0, the IDC release indicator is configured to 1.

17. A Base Station (BS) for controlling In-Device Coexistence interference (IDC) in a wireless communication system, the BS comprising:
receiving unit receiving, from a User Equipment (UE), capability information of whether the UE has a capability to control IDC; and
transmitting unit transmitting, to the UE, IDC indication configuration information whether the IDC is on-going;
wherein the receiving unit receives, from the UE, a measurement result in consideration of IDC or a measurement result without consideration of IDC and IDC indication based on the IDC indication configuration information.

18. The BS of claim 17, wherein the receiving unit receives the IDC indication comprising an IDC entry indicator indicating whether the IDC entry triggering, which triggers an event representing IDC on-going situation starts, has been performed and an IDC release indicator indicating whether the IDC release triggering, which triggers a event representing IDC on-going situation ends, has been performed.

19. The BS of claim 18, wherein the IDC entry indicator and the IDC release indicator are configured to be connected.

20. The BS of claim 19, wherein if the IDC entry indicator is 1, the IDC release indicator is configured to 0, but if the IDC release indicator is 0, the IDC release indicator is configured to 1.
